(19) United States
(12) Patent Application Publication
(10) Pub. No.: US 2026/0162078 A1
(43) Pub. Date: Jun. 11, 2026

(54) INTEGRATED MACHINE LEARNING AND OPTIMIZATION SYSTEMS AND METHODS FOR INFRASTRUCTURE ASSET MAINTENANCE PLANNING

(71) Applicant: The Regents of the University of Colorado, a body corporate, Denver, CO (US)

(72) Inventors: Farnoush Banaei-Kashani, Denver, CO (US); Moatassem Abdallah, Denver, CO (US)

(21) Appl. No.: 19/415,476

(22) Filed: Dec. 10, 2025

Related U.S. Application Data
(60) Provisional application No. 63/730,412, filed on Dec. 10, 2024.
(60) Provisional application No. 63/730,405, filed on Dec. 10, 2024.

(51) Int. Cl. G06Q 10/20; G01M 5/00

(52) U.S. Cl. CPC G06Q 10/20; G01M 5/0033

(57) ABSTRACT

A system for forecasting deterioration of infrastructure assets comprises one or more processors and a memory storing instructions that cause the system to perform: preprocessing characteristic data from a first database and conditioning data from a second database for a list of infrastructure assets, selecting features affecting deterioration of elements of the list of infrastructure assets based on the characteristic data and the conditioning data, developing machine learning models to predict a health index of each element of the list of infrastructure assets, based on the selected features, identifying a list of decision variables to predict maintenance interventions for the elements based on predicted health indexes and maintenance data from a third database, formulating an objective function based on the maintenance data and the identified list of decision variables, and outputting maintenance intervention plans that optimize performance of the list of infrastructure assets and comply with the maintenance data.

### CROSS-REFERENCE TO RELATED APPLICATIONS

This application claims priority to and benefit of U.S. Provisional Patent Application No. 63/730,412 filed on Dec. 10, 2024, titled “INTEGRATED MACHINE LEARNING AND OPTIMIZATION SOFTWARE FOR BRIDGE MAINTENANCE PLANNING,” and U.S. Provisional Patent Application No. 63/730,405, filed on Dec. 10, 2024, titled “INTEGRATED MACHINE LEARNING AND OPTIMIZATION SOFTWARE FOR BRIDGE MAINTENANCE PLANNING,” which are expressly incorporated herein by reference in their entirety.

### FIELD

The present invention generally relates to management and forecasting systems and methods, and particularly relates to infrastructure asset management and condition forecasting systems and methods for planning and scheduling maintenance interventions for infrastructure assets by using physics-guided machine learning architectures and optimizing model development based on objective functions and constraints.

### BACKGROUND

Infrastructure assets, such as bridges and culverts, across the United States have been aging rapidly and require timely maintenance to ensure public safety and to maintain transportation system functionality. Traditional condition forecasting methods, such as Markov deterioration models, deterministic regression models, time-based probabilistic models (e.g., Weibull), and mechanistic corrosion-based models, exhibit limitations including low predictive accuracy, oversimplified assumptions, and lack of adaptability to local conditions.

Many existing machine learning methods used for estimating bridge deterioration rely on historical National Bridge Inventory (NBI) condition ratings, which are reported as coarse integer values that do not capture the full complexity of the deterioration processes. Such models typically do not incorporate environmental or climatic variables, do not integrate traffic loading, and often fail to handle variable time-series length or missing data.

Moreover, current machine learning approaches rarely incorporate physics-based constraints, which are essential for ensuring that model predictions respect fundamental engineering principles such as monotonic deterioration in the absence of repair. Without such constraints, machine-learning models may produce predictions that violate physical reality.

Repair events further complicate deterioration forecasting, as sudden increases in condition ratings disrupt temporal patterns. Conventional models either ignore repair events or treat them as noise, resulting in distorted deterioration trajectories and poor forecast accuracy.

In parallel, maintenance planning and scheduling systems used by transportation agencies typically rely on simplistic heuristics, condition thresholds, or ad-hoc engineering judgment. These systems lack integration with predictive models that could inform maintenance actions years in advance. As a result, agencies may make suboptimal maintenance decisions, leading to increased lifecycle costs and degraded system performance.

Even though previous research contributes over identifying optimal maintenance interventions, the results of these studies have been limited by solution quality (i.e., the optimality of the solutions provided) or computational efficiency (i.e., the computational time required to generate the solutions). Further, there have not been reported studies that present data-driven models that are capable of identifying optimal selection of maintenance interventions for bridge elements and their timing to maximize the performance of bridges while complying with available annual budgets. Further, no known systems provide a unified framework combining physics-guided machine-learning deterioration forecasting, multimodal feature selection, automatic repair event detection, temporal neural network architectures, and multi-objective optimization for maintenance planning for infrastructure assets such as bridges and culverts.

### BRIEF SUMMARY

The present disclosure is related to infrastructure asset management and condition forecasting systems, methods, and computer-readable media for planning and scheduling maintenance interventions for infrastructure assets by using physics-guided machine learning architectures and optimizing model development based on objective functions and constraints. Due to the disclosed features, more reliable forecasts can be achieved by improving the model performance, effective maintenance interventions can be made in a timely manner, and the need for costly interventions can be avoided.

According to various aspects of the present disclosure, a system for forecasting deterioration of infrastructure assets comprises one or more processors; and a memory storing instructions. When executed by the one or more processors, the instructions cause the system to perform: preprocessing characteristic data from a first database for a list of infrastructure assets and conditioning data from a second database for the list of infrastructure assets, selecting features affecting deterioration of elements of the list of infrastructure assets based on the characteristic data and the conditioning data, developing machine learning models to predict a health index of each element of the list of infrastructure assets, based on the selected features, identifying a list of decision variables to predict maintenance interventions for the elements of the list of infrastructure assets based on predicted health indexes and maintenance data from a third database, formulating an objective function based on the maintenance data and the identified list of decision variables, and outputting maintenance intervention plans that optimize performance of the list of infrastructure assets and comply with the maintenance data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the present disclosure may be realized and obtained by means of the instruments and combinations particularly pointed out in the appended claims. Features of the present disclosure will become more fully apparent from the following description and appended claims, or may be learned by the practice of the present disclosure as set forth hereinafter.

### BRIEF DESCRIPTION OF THE DRAWINGS

In order to describe the manner in which at least some of the advantages and features of the present disclosure may be obtained, a more particular description of aspects of the present disclosure will be rendered by reference to specific aspects thereof which are illustrated in the appended drawings. Understanding that these drawings depict only typical aspects of the present disclosure and are not therefore to be considered to be limiting of its scope, aspects of the present disclosure will be described and explained with additional specificity and detail through the use of the accompanying drawings.

FIG. 1 illustrates a block diagram of a system for forecasting deterioration of infrastructure assets according to various aspects of the present disclosure.

FIG. 2 illustrates exemplary data operations from databases according to various aspects of the present disclosure.

FIG. 3 illustrates examples of elements of bridge according to various aspects of the present disclosure.

FIGS. 4A-4D illustrate SHAP summary plots of SHAP analyses for deck, superstructure, substructure, and culvert according to various aspects of the present disclosure.

FIGS. 5A and 5B illustrate comparison bar charts for prediction results of deck according to various aspects of the present disclosure.

FIGS. 5C and 5D illustrate comparison bar charts for predicting results of superstructure according to various aspects of the present disclosure.

FIGS. 5E and 5F illustrate comparison bar charts for predicting results of substructure according to various aspects of the present disclosure.

FIGS. 5G and 5H illustrate comparison bar charts for prediction results of culvert results according to various aspects of the present disclosure.

FIG. 6 illustrates comparison bar charts for all features versus best features of deck according to various aspects of the present disclosure.

FIG. 7 illustrates a heatmap of various features on deterioration of bridge elements according to various aspects of the present disclosure.

FIG. 8 illustrates a table of predictive performance of developed machine learning models according to various aspects of the present disclosure.

FIG. 9 illustrates a table of exemplary bridge characteristics according to various aspects of the present disclosure.

FIG. 10A illustrates average bridge performance for specified annual budgets according to various aspects of the present disclosure.

FIG. 10B illustrates bridge performance over time under various annual budgets according to various aspects of the present disclosure.

FIG. 11 illustrates an exemplary action report of maintenance intervention with an annual budget according to various aspects of the present disclosure.

FIG. 12 illustrates a flowchart of a method for forecasting deterioration of infrastructure assets according to various aspects of the present disclosure.

FIG. 13 illustrates a block diagram for a computing device according to various aspects of the present disclosure.

### DETAILED DESCRIPTION

The following detailed description is provided to enable any person skilled in the art to make and use the present disclosure. Various modifications will be readily apparent to those skilled in the art, and the general principles defined herein may be applied to other embodiments and applications without departing from the spirit and scope of the invention. Thus, this present disclosure is not intended to be limited to the embodiments or aspects shown, but is to be accorded with the widest scope consistent with the principles and novel features disclosed herein.

Following table shows acronyms and definitions thereof used in this disclosure.

| Abbreviation | Definition |
|---|---|
| RSME | Root Mean Square Error |
| LSTM | Long Short Term Memory |
| GRU | Gated Recurrent Unit |
| TCN | Temporal Convolutional Network |
| BiLSTM | Bidirectional Long Short Term Memory |
| CNN | Convolutional Neural Network |
| ReLU | Rectified Linear Activation Unit |
| ANN | Artificial Neural Network |
| NBI | National Bridge Inventory |
| CDOT | Colorado Department of Transportation |
| FFS | Full Factorial-based Simulations |
| GLEAM | Global Epidemic and Mobile Model |
| DCRNN | Diffusion Convolutional Recurrent Neural Network |
| NOAA | National Oceanic and Atmospheric Administration's |
| MSE | Mean Square Error |
| MAE | Mean Absolute Error |
| MAPE | Mean Absolute Percentage Error |

Transportation agencies face significant challenges in predicting deterioration of bridge and culvert structures due to the limitations of existing forecasting methodologies. Traditional models such as Markov chains, deterministic regressions, and mechanistic corrosion models rely on coarse condition ratings, oversimplified assumptions, and static parameterization. These approaches cannot fully capture the complex temporal behavior of real structural deterioration especially under varying climatic, traffic, and design conditions. Furthermore, existing machine-learning models commonly ignore physics-based constraints and treat repair events as anomalies, resulting in predictions that can violate engineering principles (e.g., unphysical condition improvements) or distort long-term deterioration trends. The lack of reliable forecasting cascades into poor planning decisions, inefficient allocation of limited budgets, and increased lifecycle costs.

The second major problem lies in the absence of an integrated, data-driven maintenance optimization system that works in tandem with accurate deterioration forecasts. Conventional maintenance planning practices typically rely on fixed thresholds or engineering judgement, without formal optimization or insight into future structural conditions. As a result, agencies frequently perform reactive, piecemeal repairs rather than strategically timed, cost-effective maintenance interventions. Without mathematical optimization, it is difficult to determine which elements to repair, when to intervene, what combination of actions yields the best long-term performance, or how to allocate constrained budgets across thousands of structures. Existing systems do not compute Health Index values consistently nor identify Pareto-optimal solutions balancing cost and performance across multi-year planning horizons.

The present disclosure solves these problems through a unified platform that integrates physics-guided machine-learning deterioration forecasting with a multi-objective maintenance optimization framework. The forecasting system may use multimodal data (NBI, NOAA weather, traffic), rigorous two-stage feature selection (logistic regression and SHAP), temporal neural networks (TCN, LSTM, GRU, CNN-BILSTM), and a physics-guided loss function that enforces monotonic deterioration except during detected repair events. This produces accurate, physically consistent predictions and isolates repair segments for improved learning. The optimization engine then uses these predictions to compute maintenance decision variables, enforce budget and performance constraints, and generate optimal, cost-minimizing action plans across multiple years. Combined, the present disclosure enables proactive, data-driven, and cost-efficient bridge asset management, fundamentally improving decision-making and long-term infrastructure performance.

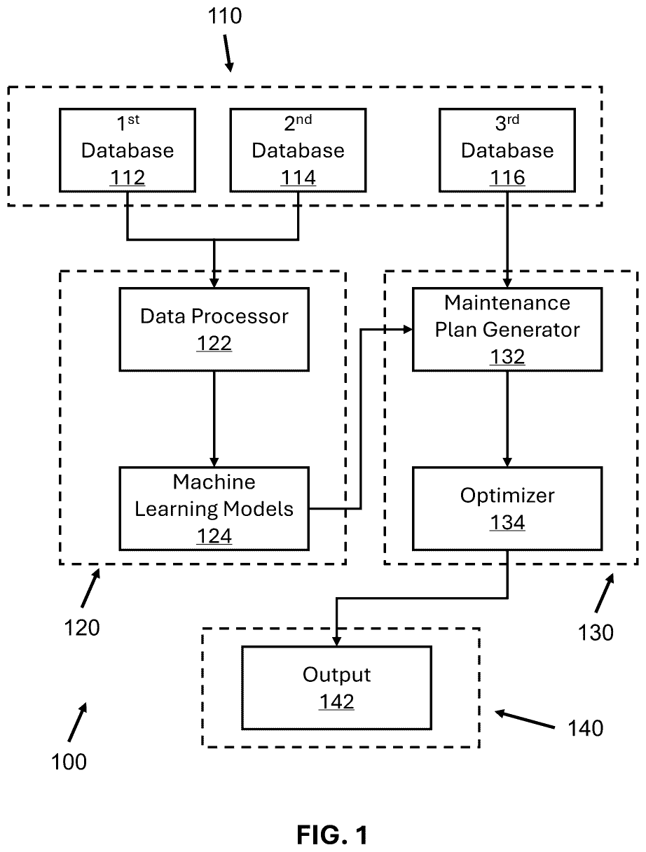

Referring now to FIG. 1, illustrated is a system 100 for forecasting deterioration of infrastructure assets according to various aspects of the present disclosure. The system 100 may utilize various databases and machine learning (ML) models to make a maintenance intervention action report for infrastructure assets in a list. The ML models are aligned with underlying physical principles of deterioration in infrastructure assets. Further, repair reports and constraints (e.g., annual budgets) may be incorporated into the system 100 so that more predictable maintenance intervention plans may be output with higher accuracy and reliability compared to conventional methods.

The system 100 may include an infrastructure asset deterioration model module 120, a maintenance optimization model 130, and a maintenance plan output module 140. The infrastructure asset deterioration model module 120 may include a data processor 122, which processes data, and machine learning models 124, which are to be trained to predict health index (HI) of elements of infrastructure assets. When bridges and culverts are considered as examples of infrastructure assets, data 110 handled by the data processor 122 may include information from National Bridge Inventory (NBI), National Oceanic and Atmospheric Administration's (NOAA) online weather database, National Bridge Element (NBE), Bridge Elements Information and Operation Data, traffic data, and the like. The data 110 may include a first database 112, a second database 114, and a third database 116. The first database 112 may include characteristic data from NBI, which provides for each year's worth of evaluations: year built, ADT, traffic lanes on, traffic lanes under, design load, structure type, main unit spans, approach unit spans, horizontal clearance measurement, maximum span length measurement, structure length measurement, roadway width measurement, deck width measurement, deck condition rating, superstructure condition rating, substructure condition rating, culvert condition rating, channel condition rating, operating rating, inventory rating, structural evaluation, deck geometry evaluation, under clearance evaluation, posting evaluation, waterway evaluation, approach road evaluation, traffic direction, deck structure type, surface type, deck protection, percent ADT truck, future ADT.

The second database 114 may include element information from NBE, which provides a more detailed, component-level view of bridge condition and focuses on physical conditions of individual bridge elements. For example, element inventory information (e.g., ID) and conditions state data ranging from 1 to 4, material attributes (e.g., steel, prestressed concrete, timber, masonry, etc.), environment attributes (e.g., atmospheric, deicing chemicals, saltwater, etc.), defects (e.g., corrosion, cracking, spalling, and quantity or severity of defects), and location of damages (e.g., abutment, pier, deck section, etc.).

The third database 116 may include operation data (e.g., repairs, maintenances, etc.).

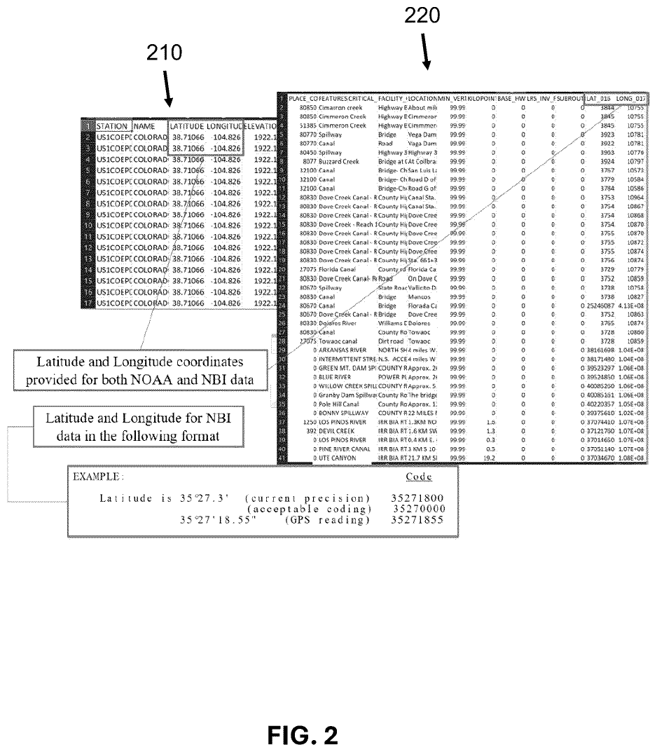

The data processor 122 may preprocess the data 110, specifically, the characteristic data from the first database 112 and the element data from the second database 114. The preprocessing may concatenate the characteristic data and the element data. Data concatenation may be performed by combining two data based on common data. For example, as illustrated in FIG. 2, data 210 from NOAA includes latitude and longitude coordinates, where the weather information is collected, and data 220 includes information from NBI, which has latitude and longitude coordinates.

Regarding the weather information, the system 100 may compute derived climate features that more directly reflect mechanisms of structural deterioration. For example, daily minimum and maximum temperatures may be analyzed to estimate the annual number of freeze-thaw cycles, which are known to accelerate cracking and spalling in concrete. Similarly, extreme-event indicators, such as the number of days below a cold threshold or above a heat threshold, and cumulative seasonal snowfall or snow depth, may be computed. These derived variables are associated with each bridge via its geographic coordinates and incorporated into the feature-selection and modeling pipeline as potential predictors of element-level deterioration.

Based on the closest latitude and longitude coordinates, both data 210 and 220 are combined or concatenated. In other words, the weather station, which is geographically closest to the bridge, is correlated to the bridge so as to combine data. This is done for each year's worth of data from both databases. Specifically, the daily weather data for each year is averaged to ensure that the frequency of time steps for each dataset matched. Likewise, based on the common information (e.g., element ID) in NBE and NBI, data from NBE and NBI can be also combined or concatenated.

After the concatenation, the data processor 122 may also perform cleaning data and removing redundancies. Further, data standardization is performed by the data processor 122 by using a standard scaler and encoding categorical data using one-hot encoding.

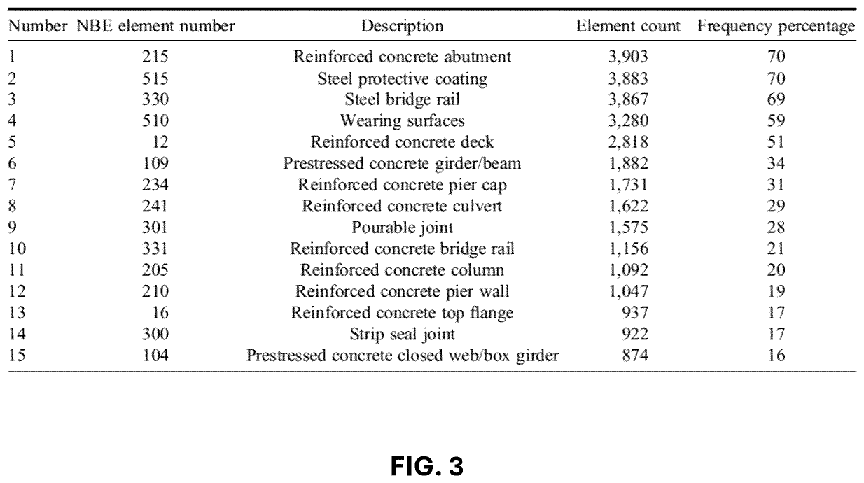

Now turning attention to FIG. 3, illustrated is a table of precent frequency of common concrete bridge elements in Colorado. Based on NBI and NBE databases, data of concrete bridges located in the state of Colorado within the time period of 2014 to 2022 are extracted and concatenated to objectively evaluate the importance of the factors affecting concrete bridge elements deterioration. Using item 43 from the NBI, which categorizes the main structure type, concrete bridges with main structure types of “Concrete”, “Concrete continuous”, “Prestressed concrete”, and “Prestressed concrete continuous” are selected, resulting in 5576 unique concrete bridges, representing 62.5% of all bridges in Colorado. The identification number of the selected concrete bridges in the NBI is used to measure the frequency of constituent elements from the NBE to identify the most frequent concrete bridge elements. The most common elements including Reinforced Concrete Deck, Reinforced Concrete Top Flange, Prestressed Concrete Closed Web/Box Girder, Prestressed Concrete Girder/Beam, Reinforced Concrete Column, Reinforced Concrete Pier Wall, Reinforced Concrete Abutment, Reinforced Concrete Pier Cap, Reinforced Concrete Culvert, Strip Seal Joint, Pourable Joint, Steel Bridge Rail, Reinforced Concrete Bridge Rail, Wearing Surfaces, and Steel Protective Coating are selected for analysis.

The NBI and NBE databases are then concatenated using the bridge identification number or NBE element number and year of inspections to generate a comprehensive and uniform database. The NBI contains data on bridge design, specification, operational data, and condition rating of primary components, such as deck, superstructure, and substructure. Out of 142 features reported in the NBI, 72 features that have no impact on bridge element deterioration are eliminated. For example, item 19, which specifies the bypass/detour length, was removed as it does not affect deterioration of the bridge elements. Furthermore, 15 features that report similar information are removed to minimize multicollinearity among the predictor features. For example, item 9, which reports the location of bridges, was eliminated as it reports the same information as items 16 and 17, longitude and latitude, respectively. Additionally, 9 features related to NBI condition ratings and inspections are removed as the objective is to predict the HI based on factors affecting bridge deterioration. After removing the redundant features in the preprocessing step performed by the data processor 122, the numeric data is standardized using the standard scaler, and categorical data was encoded using “One-hot encoding”.

After the reduction and cleaning of the data, all remaining elements may be input to the ML models 124. In an aspect, elements, whose frequency percentage is less than a predetermined threshold (e.g., 1%, 2%, 5%, or any percentage greater than 5% and less than or equal to 10%), may be removed from the data to be input to the ML models 124.

Due to installation or removal of elements along the passage of time and addition or removal of data items to and from the databases 112 and 114, variable lengths of datasets may occur. To accommodate the variable lengths of sequences resulting from our data preparation method, a masking mechanism may be coupled with zero padding in our model architecture.

Zero padding mechanism ensures that the ML models 124 may be able to effectively handle sequences of varying lengths without compromising computational efficiency or model performance. Specifically, sequences in the dataset from the databases 112 and 114 are padded with zeros to align with the maximum sequence length encountered in the dataset.

The masking mechanism may be applied to ignore the padded zeros during computation focusing only on actual data points. This prevents the ML models 124 from assigning significance to padding tokens, thereby improving the accuracy of predictions on real data.

In various aspects, a two-step feature importance analysis methodology may be employed to identify the most important features for bridge structure deterioration forecasting, aiming for efficiency and reduced computational overhead. A set of features may be initially selected based on domain expert knowledge. Then, logistic regression may be employed for the primary feature importance analysis. Logistic regression may be chosen for its simplicity and interpretability, making it easier to understand the relationship between the features and the target variable, especially when dealing with continuous predictors. This step can identify a set of the most important features, and by averaging the single feature importance values across all years in the preprocessed dataset, they are ranked from high to low average values. Any averaged values, which are below the predetermined threshold value, are removed from the dataset.

In the second step, feature importance values may be computed to measure contribution of each element to deterioration of infrastructure assets. In an aspect, the SHAP (SHapley Additive explanations) algorithm may be used to identify the top 15 most important features selected from the first step. The SHAP algorithm is for interpreting outputs of machine learning models, providing insights into the contribution of each feature. By using the SHAP algorithm, the feature selection process can be further refined, thereby ensuring that the most impactful features can be focused on. From this analysis, the top-ranked features based on SHAP values are used to train our the ML models 124. It can help users understand and trust a model's decisions. It can provide a global summary of a model in the form of a SHAP value summary plot. It gives an overview of the most important features across the entire dataset. This methodology is performed for all four structure types, including deck, superstructure, substructure, and culvert.

Particularly, the SHAP algorithm quantifies the contribution of each feature to predictions made by a model, ensuring a consistent and interpretable assessment of feature importance, which is expressed in Shapley values, providing a robust framework for interpreting machine learning models.

SHAP values attribute a fair importance score to each feature by considering all possible combinations of features. This ensures that the contribution of a feature is assessed in various contexts, capturing how it interacts with other features. For each feature, SHAP calculates its marginal contribution, which is the change in the model's output when the feature is added to a subset of other features. This involves computing the prediction difference with and without the feature in various subsets. The marginal contributions of a feature are averaged across all possible subsets of features. This averaging process ensures that the importance score reflects the feature's overall impact on the model's predictions, considering different scenarios. By averaging the marginal contributions, SHAP ensures that the feature importance scores are both fair and consistent. This means that the sum of the SHAP values of all features equals the difference between the model's prediction and the average prediction, ensuring additive consistency. SHAP provides clear and interpretable explanations for model predictions. Each SHAP value indicates how much a feature contributes to increasing or decreasing the model's prediction.

The SHAP analysis may be used to identify and rank the most predictive features among a comprehensive set of candidate features related to bridge performance, such as structural attributes, condition ratings, weather data, and traffic patterns. By leveraging SHAP values, the redundancy can be reduced, thereby improving the computational efficiency and accuracy of the bridge deterioration forecasting models.

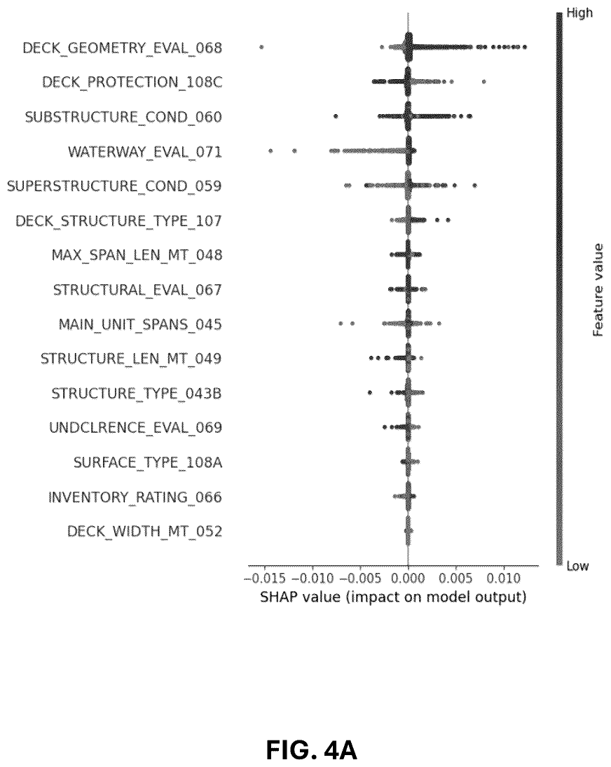

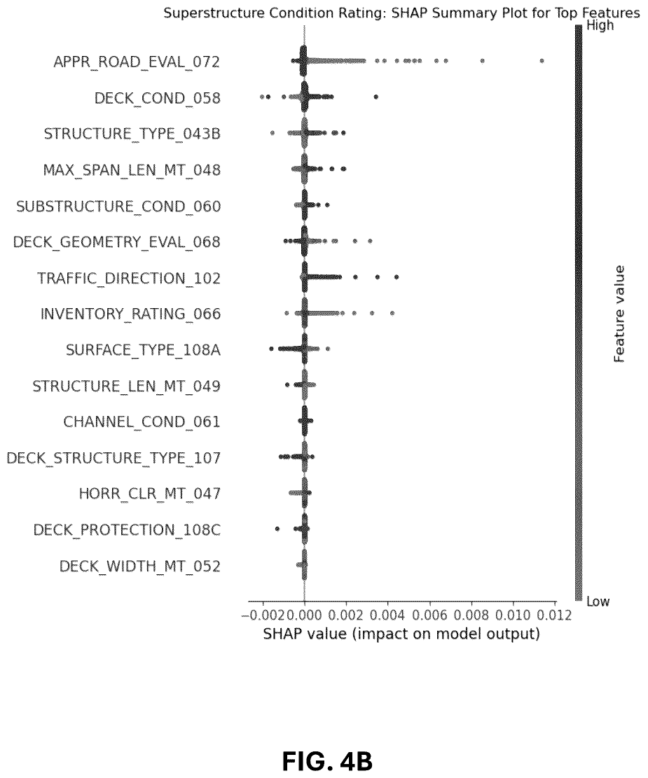

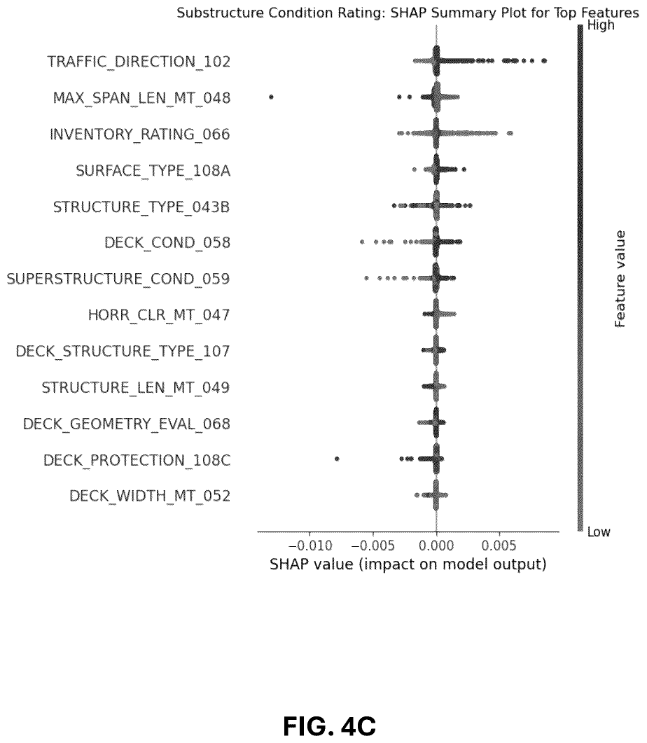

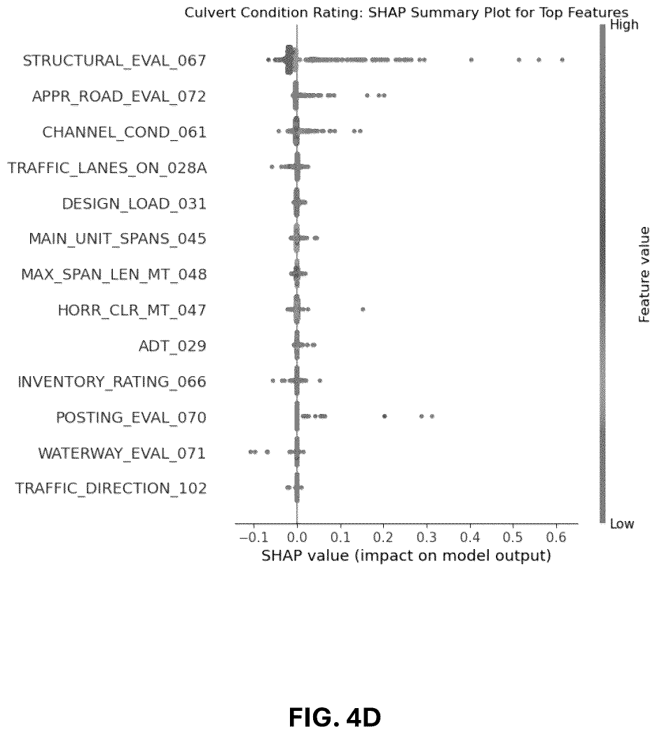

Turning now to FIGS. 4A-4D, illustrated are summary plots for condition rating in the descending order along the down direction. The top 15 or 13 most influential features are shown in the vertical axis in order and SHAP values are shown in the horizonal axis for four elements of the infrastructure assets: deck, superstructure, substructure, and culvert. For example, the top contributing feature toward deterioration of the deck according to FIG. 4A is DECK_GEOMETRY_EVAL_068, which is an evaluation score for the deck geometry, and the top contributing feature deterioration of the superstructure according to FIG. 4B is APPR_ROAD_EVAL_072, which is an evaluation of the adequacy of the approach roadway alignment. Following table below includes the most influential features shown in FIGS. 4A-4D and description thereof.

TABLE 1
DATA FEATURES DESCRIPTION

| Feature | NBI Item No. | Description | Data Type | Forecasting condition |
|---|---|---|---|---|
| Year Built | 027 | The construction year of the structure | Datetime | Deck, Superstructure, |
| | | | | Substructure, Culvert |
| ADT | 029 | Number showing the average daily | Number | Deck, Superstructure, |
| | | traffic volume of a bridge structure | | Substructure, Culvert |
| Traffic Lanes on | 028A | Number of traffic lanes on a | Number | Deck, Superstructure, |
| | | bridge structure | | Substructure, Culvert |
| Traffic Lanes | 028B | Number of traffic lanes under a | Number | Deck, Superstructure, |
| Under | | bridge structure | | Substructure, Culvert |
| Design Load | 031 | The live load for which the | Number | Deck, Superstructure, |
| | | structure was designed | | Substructure, Culvert |
| Structure Type | 043B | Type of structural design of the | Number | Deck, Superstructure, |
| | | construction | | Substructure, Culvert |
| Main Unit | 045 | The number of spans in the main unit | Number | Deck, Superstructure, |
| Spans | | | | Substructure, Culvert |
| Appr Unit Spans | 046 | The number of approach spans in the | Number | Deck, Superstructure, |
| | | major bridge | | Substructure, Culvert |
| Horizontal | 047 | The largest available horizontal | Number | Deck, Superstructure, |
| Clearance | | clearance for the movement of wide | | Substructure, Culvert |
| Measurement | | loads | | |
| Maximum Span | 048 | The length of the maximum span | Number | Deck, Superstructure, |
| Length | | | | Substructure, Culvert |
| Measurement | | | | |
| Structure Length | 049 | The length of the structure to the | Number | Deck, Superstructure, |
| Measurement | | nearest tenth of a meter | | Substructure, Culvert |
| Roadway Width | 051 | The most restrictive minimum | Number | Deck, Superstructure, |
| Measurement | | distance between curbs or rails on | | Substructure |
| | | the structure roadway | | |
| Deck Width | 052 | The out-to-out width to the nearest | Number | Deck, Superstructure, |
| Measurement | | tenth of a meter | | Substructure |
| Deck Condition | 058 | Number describing the overall | Number | Deck, Superstructure, |
| Rating | | condition rating of the bridge deck (1 | | Substructure |
| | | to 9) | | |
| Superstructure | 059 | Number describing the physical | Number | Deck, Superstructure, |
| Condition | | condition of all structural members | | Substructure |
| Rating | | (1 to 9) | | |
| Substructure | 060 | Number describing the physical | Number | Deck, Superstructure, |
| Condition | | condition of piers, abutments, piles, | | Substructure |
| Rating | | fenders, and footings (1 to 9) | | |
| Culvert | 062 | The physical condition rating that | Number | Culvert |
| Condition Rating | | evaluates the alignment, settlement, | | |
| | | joints, structural condition, scour, | | |
| | | and other items associated with | | |
| | | culverts | | |
| Channel | 061 | The physical conditions associated | Number | Deck, Superstructure, |
| Condition | | with the flow of water through the | | Substructure, Culvert |
| Rating | | bridge | | |
| Operating | 064 | Formula combining separate factors | Number | Deck, Superstructure, |
| Rating | | to obtain a numeric value indicative | | Substructure, Culvert |
| | | of bridge sufficiency to remain in | | |
| | | service | | |
| Inventory Rating | 066 | A load level which can safely utilize | Number | Deck, Superstructure, |
| | | an existing structure for an indefinite | | Substructure, Culvert |
| | | period of time | | |
| Structural | 067 | The evaluation score of the structure | Number | Deck, Superstructure, |
| Evaluation | | | | Substructure, Culvert |
| Deck Geometry | 068 | The evaluation score for the deck | Number | Deck, Superstructure, |
| Evaluation | | geometry | | Substructure |
| Under Clearance | 069 | The measures for the Vertical and | Number | Deck, Superstructure, |
| Evaluation | | horizontal under clearances | | Substructure |
| Posting | 070 | The posting of load limits when | Number | Deck, Superstructure, |
| Evaluation | | the maximum legal load in the | | Substructure, Culvert |
| | | State exceeds the load permitted | | |
| | | under the operating rating | | |
| Waterway | 071 | The chance of overtopping the bridge | Number | Deck, Superstructure, |
| Evaluation | | | | Substructure, Culvert |
| Approach Road | 072 | The evaluation of the adequacy of | Number | Deck, Superstructure, |
| Evaluation | | the approach roadway alignment | | Substructure, Culvert |
| Traffic Direction | 102 | The direction of traffics | Number | Deck, Superstructure, |
| | | | | Substructure, Culvert |
| Deck Structure | 107 | Type of deck structure | Number | Deck, Superstructure, |
| Type | | | | Substructure |
| Surface Type | 108A | The wearing surface of the bridge | Number | Deck, Superstructure, |
| | | deck | | Substructure |
| Deck Protection | 108C | The protective system of the bridge | Number | Deck, Superstructure, |
| | | | | Substructure |
| Percent ADT | 109 | The percentage of average daily | Number | Deck, Superstructure, |
| Truck | | truck traffic | | Substructure, Culvert |
| Future ADT | 114 | Future average daily traffic | Number | Deck, Superstructure, |
| | | | | Substructure, Culvert |
| Channel | 061 | The physical conditions associated | Number | Deck, Superstructure, |
| Condition | | with the flow of water through the | | Substructure, Culvert |
| Rating | | bridge | | |
| Operating | 064 | Formula combining separate factors | Number | Deck, Superstructure, |
| Rating | | to obtain a numeric value indicative | | Substructure, Culvert |
| | | of bridge sufficiency to remain in | | |
| | | service | | |
| Inventory Rating | 066 | A load level which can safely utilize | Number | Deck, Superstructure, |
| | | an existing structure for an indefinite | | Substructure, Culvert |
| | | period of time | | |
| Structural | 067 | The evaluation score of the structure | Number | Deck, Superstructure, |
| Evaluation | | | | Substructure, Culvert |
| Deck Geometry | 068 | The evaluation score for the deck | Number | Deck, Superstructure, |
| Evaluation | | geometry | | Substructure |
| Under Clearance | 069 | The measures for the Vertical and | Number | Deck, Superstructure, |
| Evaluation | | horizontal under clearances | | Substructure |
| Posting | 070 | The posting of load limits when | Number | Deck, Superstructure, |
| Evaluation | | the maximum legal load in the | | Substructure, Culvert |
| | | State exceeds the load permitted | | |
| | | under the operating rating | | |
| Waterway | 071 | The chance of overtopping the bridge | Number | Deck, Superstructure, |
| Evaluation | | | | Substructure, Culvert |
| Approach Road | 072 | The evaluation of the adequacy of | Number | Deck, Superstructure, |
| Evaluation | | the approach roadway alignment | | Substructure, Culvert |
| Traffic Direction | 102 | The direction of traffics | Number | Deck, Superstructure, |
| | | | | Substructure, Culvert |
| Deck Structure | 107 | Type of deck structure | Number | Deck, Superstructure, |
| Type | | | | Substructure |
| Surface Type | 108A | The wearing surface of the bridge | Number | Deck, Superstructure, |
| | | deck | | Substructure |
| Deck Protection | 108C | The protective system of the bridge | Number | Deck, Superstructure, |
| | | | | Substructure |
| Percent ADT | 109 | The percentage of average daily | Number | Deck, Superstructure, |
| Truck | | truck traffic | | Substructure, Culvert |
| Future ADT | 114 | Future average daily traffic | Number | Deck, Superstructure, |
| | | | | Substructure, Culvert |

Now returning back to FIG. 1, after the selection of best features, the ML models 124 may utilize the selected features to predict a health index (HI) of each element of the infrastructure assets based and to identify optimal selection of maintenance interventions and their timing to maximize performance of bridges within available budgets. The HI represents the assessment of the condition rating for individual infrastructure asset (e.g., bridge or culvert) elements on a scale ranging from 0 to 100. The condition states of good, fair, poor, and severe correspond to s=1 to s=4, respectively. Converting the condition states of a bridge element into HI results in the loss of information. In cases, different condition states of the same element can yield identical HI values, resulting in a reduction in the level of detail from distinct condition states to a single HI value. Nonetheless, an HI value declines over time due to factors such as traffic loading and environmental factors, reflecting the element's deterioration. Maintenance and rehabilitation interventions can improve the overall condition of the bridge structure and, consequently, enhance the HI value. With these reasons, the HI can be used for making structural health comparisons and allocating resources for maintenance interventions. The HI value may be calculated by the following equation:

$$HI = \frac{{\sum }_{s = 1}^{4} {k}_{s} {q}_{s}}{{\sum }_{s = 1}^{4} {q}_{s}} \times 100 , \qquad Eq . ( 1 )$$

where s is the index of each condition state, q_s is the element quantity in s^{th} state, and k_s is the health index coefficient corresponding to the s^{th} condition state, k₁ to k₄ are 1.00, 0.67, 0.33, and 0.00, respectively.

To better predict HI values for elements of the infrastructure assets, the difference between the predicted HI value and the actual HI value needs to be decreased. In various aspects, a physics-guided loss function may be generated to incorporate a physical constraint to the loss function. The physics-guided loss function may be in the following form:

$$arg {min}_{f} {\underbrace{Loss ( \hat{Y} , Y )}}_{Empirical Error} + {\underbrace{λ R ( f )}}_{Structural Error} + {\underbrace{{λ}_{PHY} Loss . PHY ( \hat{Y} )}}_{Physical Inconsistency} , \qquad Eq . ( 2 ) ,$$

where the first term represents an empirical error, the second term represents the structural error, and the third term represents the physical inconsistency. The empirical error indicates how well the predicted HI fits the actual HI, the structural error indicates how complex the ML models 124 is and penalizes the ML models 124 that overfit the data, and the physical inconsistency occurs when the ML models 124 predicts the HI that contradicts the fundamental deterioration process. For example, the dock condition is increased without any repair along the passage of time. Since the condition cannot generally improve, such increase in the deck condition violates the physical principle. Further, when the predicted HI (e.g., −1.2) is out of the normal range (e.g., between 0 and 9), the predicted HI of −1.2 is physically inconsistent.

The third term includes λ_{PHY}, which is a weighting factor for Loss.PHY(Ŷ) controlling how strongly complexity is penalized, and Loss.PHY(Ŷ), which is expressed as follows:

$$Loss . PHY ( \hat{Y} ) = \frac{1}{N} {\sum }_{i = 1}^{N} Re LU ( {Δ}_{i} ) , \qquad Eq . ( 3 )$$

where N is the number of samples in the dataset, ReLU represent rectified linear unit penalty, and Δᵢ is the physical violation magnitude or the difference between the predicted value ŷₗ and the actual value yᵢ. In a case when Δᵢ is greater than zero, the ML model predicts that a structure's condition is better than the ground truth without evidence of repair, or in other words, this case is physically impossible. In another case when Δᵢ is less than or equal to zero, the prediction is physically consistent. In this regard, when Δᵢ is greater than zero, ReLU(Δᵢ) is equal to Δᵢ or the penalty is equal to the inconsistency, and when Δᵢ is less than or equal to zero, ReLU(Δᵢ) is equal to 0 or in other words, there is no penalty. According to Eq. (3), Loss.PHY(Ŷ) represents an average or normalized penalty. Thus, the physical inconsistency is a weighted average or normalized penalty.

Thus, the final loss including both the empirical loss and physical inconsistency, which is optimized using backpropagation is as follows:

$$Loss ( \hat{y} ) = \frac{{\sum }_{i = 1}^{N} {( {y}_{i} - \hat{{y}_{ι}} )}^{2}}{N} + \frac{1}{N} {\sum }_{i = 1}^{N} Re LU ( {Δ}_{i} ) , \qquad Eq . ( 4 )$$

where N is the total number of data in the dataset, yᵢ is the i^{th} HI value, and ŷₗ is the predicted i^{th} HI value.

The neural network may add the physics-guided loss function to machine learning models. A temporal convolutional network (TCN) model may be the neural network used in the physics-guided loss function added machine learning model.

The TCN may be a 1-D fully convolutional network which leverages causal and dilated convolutions to successfully obtain long term memory for time series data. The TCN may exhibit longer term memory than RNN based architectures while offering the advantage of a more stable and efficient model. This architecture is entirely convolutional and can provide time series output for variable length inputs. The TCN may use a 1-D fully convolutional network architecture where each hidden layer is the same length as the input layer and zero padding of length (kernel size−1) is added to keep subsequent layers the same length as prior layers. Causal convolutions indicates that there can be no information leakage in the model from the future into the past. The TCN accomplishes this by ensuring that outputs at time t are convolved using only elements from time t and earlier. Zero padding may be utilized to ensure that elements at the very beginning of a sequence still have values to convolve over causally.

In addition, dilated convolutions may be used in the TCN. Dilation refers to expanding the receptive field of a convolution operation by some factor, effectively adding distance between elements of an input sequence utilized when computing entries of an output sequence. This allows the model to have an exponentially larger receptive field. Via a dilation factor, the receptive field of the TCN can be increased, where a 1-D kernel is applied to a 1-D input. In an aspect, the TCN may use multivariate input by increasing the number of input channels and increasing the number of kernel input channels.

Sequences in the dataset were padded with zeros to align with the maximum sequence length encountered in our dataset. By standardizing the input sequence lengths, we facilitated batch processing and maintained consistency across training and inference phases. This combined approach of masking and zero padding was integrated into all models used in our experiments, including LSTM, BILSTM, CNN-BILSTM, CNN, Linear, GRU, Multi-channel CNN, and TCN. This methodology ensured robustness in handling variable-length sequences while optimizing computational resources during training and evaluation.

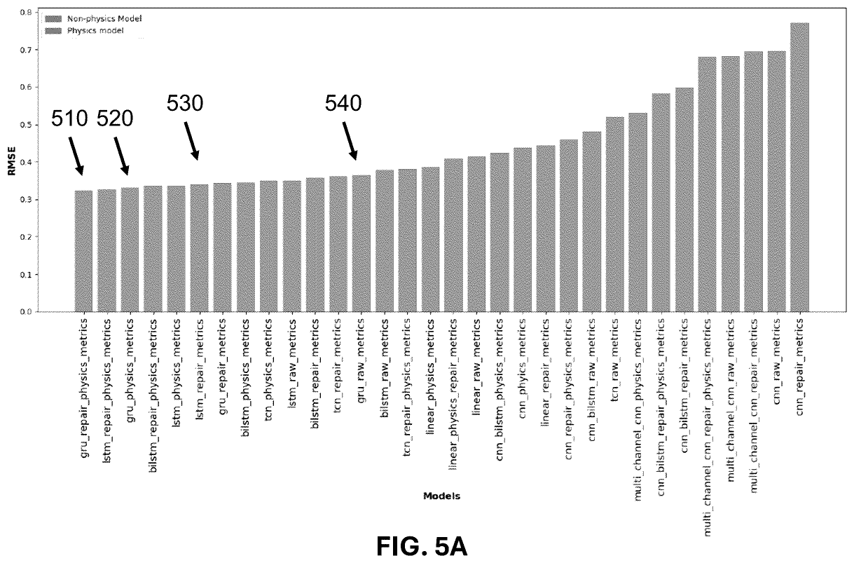

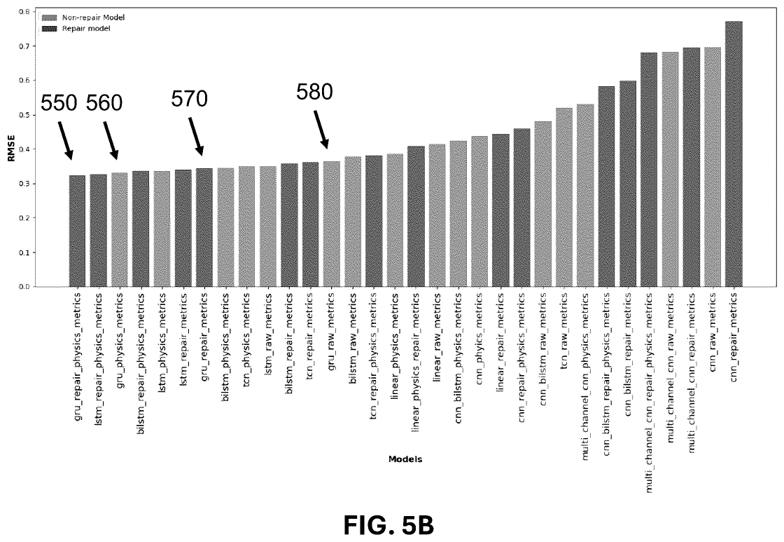

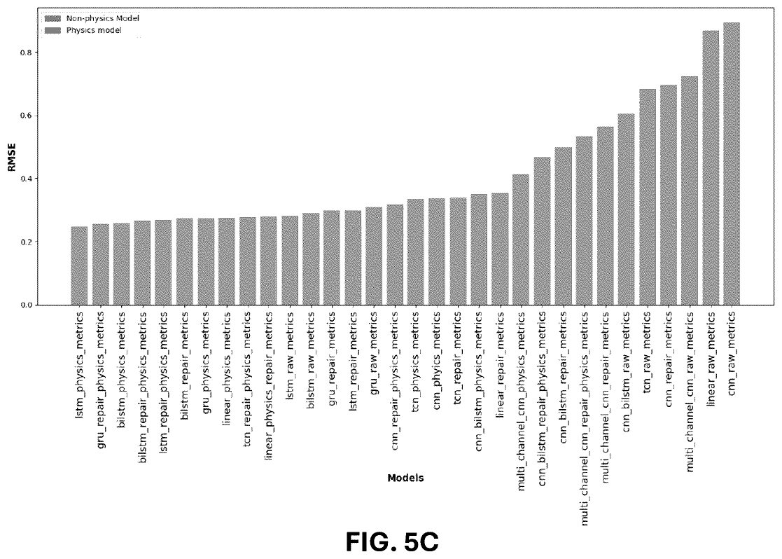

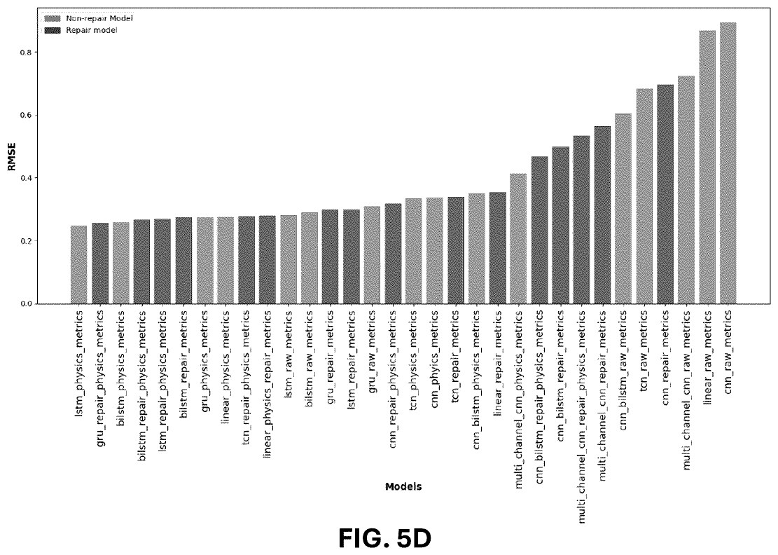

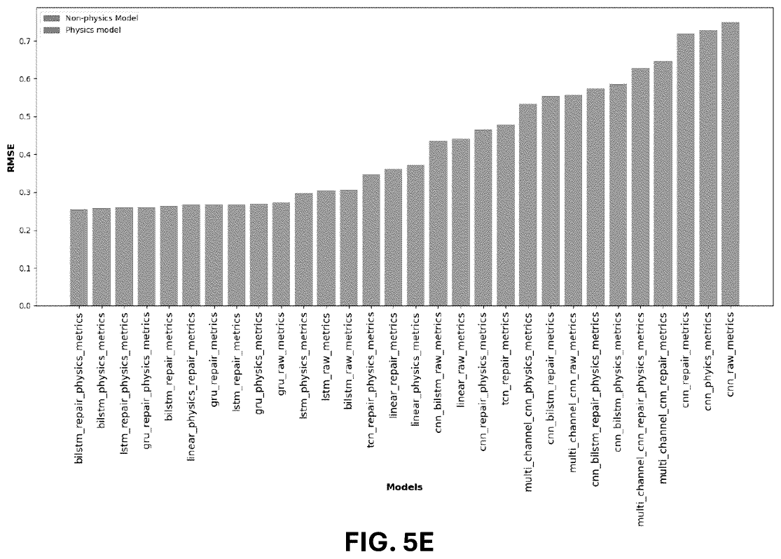

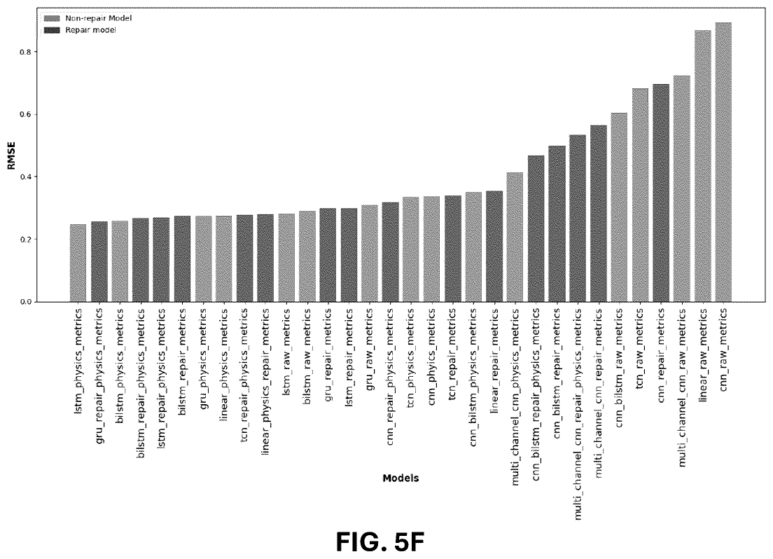

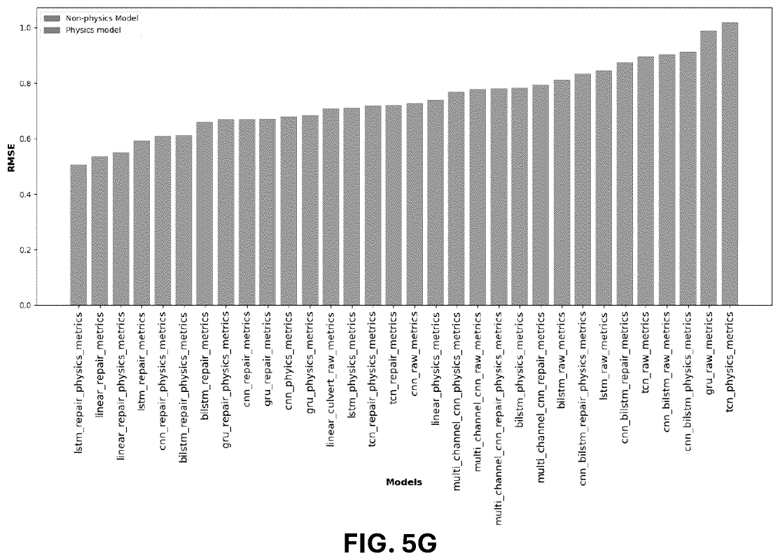

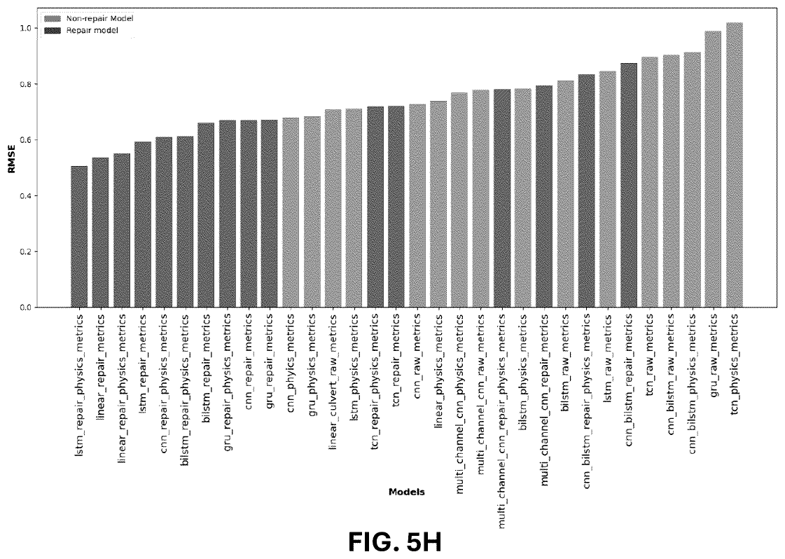

In an aspect, the ML models 124 may integrate the physics-guided loss function so as to better predict HI values for elements of the infrastructure assets. FIGS. 5A-5H illustrate bar charts for prediction results based on physics-guided models and data-driven models and based on repair event and non-repair event. The vertical axes represent RMSE and the horizontal axes represent the machine learning models with metrics. RMSE may be calculated by the following:

$$RMSE = \sqrt{\frac{{\sum }_{i = 1}^{N} {( {x}_{i} - \hat{{x}_{ι}} )}^{2}}{N}} , \qquad Eq . ( 5 )$$

where N is the total number of data in the dataset, xᵢ is the i^{th} HI value, and \hat{x}ₗ is the predicted i^{th} HI value.

The dataset from the databases 112 and 114 may be split into train data and test data. In an aspect, the split ratio between the train data and the test data may be 5:5, 6:4, 7:3, 8:2, or 9:1. The train data may be used to train the ML models 124, and the trained ML models may be tested based on the test data.

The machine learning models 124 for the comparisons include LSTM, GRU, TCN, BiLSTM, CNN, Linear, Multi-channel-CNN, and CNN BILSTM, and the metrics include raw metrics, repair metrics, and physics-guided metrics. The list of ML models and metrics are provided as examples and can include any other ML models and metrics, which are readily appreciated by persons having skill in the art. As illustrated, physics-guided metrics have smaller RMSEs than those of raw and repair metrics.

Specifically, FIGS. 5A, 5C, 5E, and 5G illustrate bar charts for prediction results for deck, superstructure, substructure, and culvert, respectively, based on the physics-guided models and data-driven model. For example, as illustrated in FIG. 5A, bin 510 represents an RMSE calculated by physics-guided GRU with a repair event; bin 520 represents an RMSE calculated by physics-guided GRU without the repair event; bin 530 represents an RMSE calculated by data-driven GRU with the repair event and without the physics-guided mechanism; and bin 540 represents an RMSE calculated by data-driven GRU without the repair event and without the physics-guided mechanism. The height of bin 510, gru_repair_physics_metrics, is smaller than that of bins 530, gru_repair_metrics, and the height of bin 520, gru_physics_metrics, is smaller than that of bins 540, gru_raw_metrics. That indicates that the physics-guided GRU has better performance in predicting an HI than the data-driven GRU.

Also, specifically, FIGS. 5B, 5D, 5F, and 5H illustrate bar charts for prediction results of deck, superstructure, substructure, and culvert, respectively, based on repair events and non-repair events. To identify instances of repair events from the dataset, a systematic approach may be employed based on changes in the bridge component rating over time. A criterion may be detection of a significant increase in the condition rating, indicative of a repair event. In other words, a repair event may be defined as a year when the bridge component rating exhibited a noticeable increase, followed by a subsequent decrease or stabilization.

Specifically, for each identified repair event year, denoted as Yᵣₑₚₐᵢᵣ, the dataset into may be segmented as distinct sequences: one corresponding to the original time series data leading up to Yᵣₑₚₐᵢᵣ, and another extending from Yᵣₑₚₐᵢᵣ to the next significant increase or change in the rating. This approach may isolate and analyze the periods directly influenced by bridge repairs separately from periods of regular maintenance or stability. Furthermore, to facilitate modeling efforts, each segmented sequence may be treated as a separate data instance. In this way, the dynamics of bridge repair impacts may be captured over time while maintaining continuity with the original dataset.

By integrating these repair-specific sequences with the primary dataset, the granularity and specificity of the analyses may be enhanced, thereby providing a more understanding of the factors influencing bridge performance and maintenance strategies. For example, as illustrated in FIG. 5B, bin 550 represents an RMSE calculated by physics-guided GRU with a repair event; bin 560 represents an RMSE calculated by physics-guided GRU without the repair event; bin 570 represents an RMSE calculated by data-driven GRU with the repair event; and bin 580 represents an RMSE calculated by data-driven GRU without the repair event. The height of bin 550, gru_repair_physics_metrics, is smaller than that of bins 560, gru_repair_metrics, and the height of bin 570, gru_physics_metrics, is smaller than that of bins 580, gru_raw_metrics. That indicates that the physics-guided GRU has better performance in predicting an HI than the data-driven GRU with or without the repair event.

It is noted that among the data-driven ML models, LSTMs, BILSTM and GRUs outperform all others in predicting His for deck, superstructure, substructure, and culvert condition ratings. One of the key reasons is that LSTMs, BiLSTM and GRUs have gated structure including the input gate, the forget gate, and the output gate. These gates enhance the network's ability to capture complex, non-linear relationships within the data, crucial for accurate forecasting.

The input gate regulates new information flow into the cell state, the forget gate determines whether or not to retain past information, and the output gate decides which part of the cell state to output at each step. This gated structure enables LSTMs and GRUs to maintain and update a dynamic memory that effectively captures dependencies in condition rating sequences. Another key reason is that the physics-guided loss models outperform all the methods as shown in FIGS. 5A-5H.

Incorporation of physics-based loss functions into these models may enhance prediction success by integrating additional features derived from real physical models. These features enable the neural network to identify and learn more physically consistent patterns during training for forecasting bridge structure deterioration. Introducing these physically consistent features can help the ML models better understand genuine patterns and behaviors of physical systems. As a result, the combination of qualitative bridge evaluation data and quantitative physics-guided features produces a more effective and accurate model. The physics-guided LSTM model leverages both the inherent temporal dependencies of the dataset and physical constraints, leading to superior performance compared to other models.

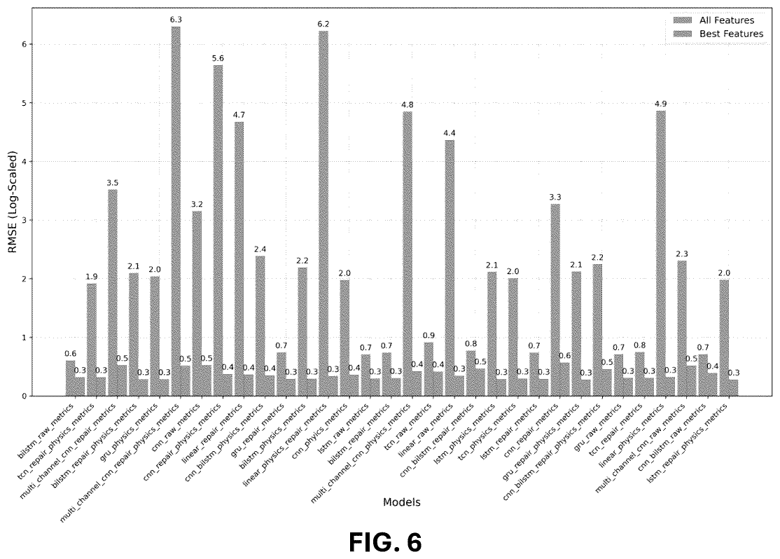

Turning now to FIG. 6, illustrated is bar charts presenting a comparative evaluation of multiple machine-learning models used for bridge element deterioration forecasting. The vertical axis represents RMSE in log scale, where lower values indicate better predictive performance. The horizontal axis lists different models evaluated, grouped by element type and model architecture. Each model appears twice: once using all available features and once using the best-performing subset of features, as determined through feature selection techniques such as SHAP. Labels placed directly on the bars quantify the RMSE values, enabling easy comparison.

As illustrated, models using all features perform substantially worse than the models using the best features. For example, a multi-channel CNN for repair physics_metrics using all features results in RMSE of 6.3, while the multi-channel CNN for repair physics metrics using best features results in RMSE of 0.3, which is twenty one times less that the former. Due to application of the log scale, the RMSE with the best features is exponentially smaller than the RMSE with all features. Likewise, RMSEs with the best features in all ML models are exponentially smaller than the RMSEs with all features.

Additionally and according to various aspects, the ML models 124 may select features that affect the deterioration of elements in the infrastructure assets based on K-Nearest-Neighbors (KNN) based mutual information (MI) estimation method over other mutual information estimation methods that use ‘binning’ of data. In this KNN-based MI method, MI between variable X and Y can be calculated based on average Iᵢ scores for all datapoints as shown in Eq. 6 to Eq. 8.

$$I ( X , Y ) = \frac{{\sum }_{i = 1}^{N} {I}_{i}}{N} , \qquad Eq . ( 6 )$$

$${I}_{i} = ψ ( N ) - ψ ( {N}_{{x}_{i}} ) + ψ ( K ) - ψ ( {m}_{i} ) , \qquad Eq . ( 7 )$$

$$ψ ( t ) = ln ( t ) - \frac{1}{2 t} , \qquad Eq . ( 8 )$$

where I(X,Y) is the MI between variable X and Y, Nₓ_{ᵢ} is the number of data points whose value equals xᵢ in entire dataset, K is the number of neighbors that is considered for the analysis, mᵢ is the number of neighbors within the distance to the K^{th} neighbor of data point i, and ψ(t) is digamma function.

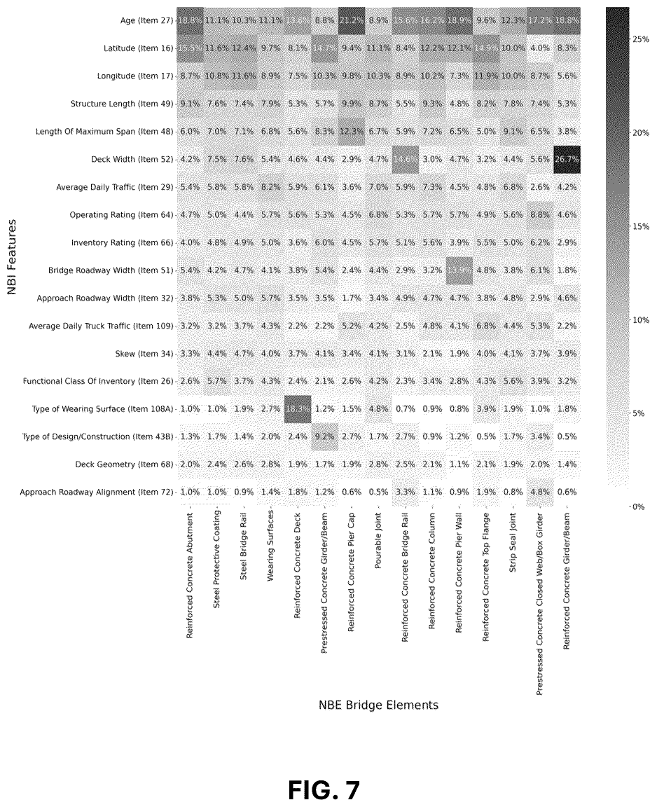

The MI represents the amount of information that a specific feature can provide about the target variable and is measured in bits. The predicted MI values for each element are then normalized by the entropy of the HI of the element, also measured in bits, to quantify how much a known feature can reduce the uncertainty in the prediction of HI. The resulting unitless values of “bits/bits” may be used to create a heat map of the top 20 features and their normalized MI for each element, as illustrated in FIG. 7.

In addition to RMSE, four commonly utilized metrics for evaluating the predictive performance of machine learning models include MAE, MSE, MAPE, and coefficient of determination (R² score), may be employed to assess the performance of the developed models. MAE measures the average absolute difference between the predicted and true values of the data points in the test data set. This metric provides a general understanding of the model's performance by conveying the magnitude of the errors made by the model in its predictions. MAE can be calculated by the following:

$$MAE ( y , \hat{y} ) = \frac{1}{{N}_{t}} {\sum }_{i = 1}^{{N}_{t}} \vert {y}_{i} - \hat{{y}_{ι}} \vert , \qquad Eq . ( 9 )$$

where Nₜ is the total number of samples in the test data, yᵢ is the true i^{th} value, ŷₗ is the predicted i^{th} value, and “∥” represents the absolute value.

MSE measures the average of the squared differences between the predicted and true values, with larger errors having a greater impact on the MSE value. This metric is more sensitive to outliers than MAE and can provide information about the model's ability to predict data points with less frequency. MSE can be calculated by the following:

$$MSE ( y , \hat{y} ) = {\sum }_{i = 1}^{{N}_{t}} \frac{{( {y}_{i} - \hat{{y}_{ι}} )}^{2}}{{N}_{t}} . \qquad Eq . ( 10 )$$

MAPE calculates the average relative error of the data points in the test data set as a percentage, which allows for comparison of error across different magnitude ranges of the true values. It can provide insight into the model's overall accuracy with respect to the magnitude of the true values. MAPE can be calculated by the following:

$$MAPE ( y , \hat{y} ) = \frac{1}{{N}_{t}} - {\sum }_{i = 1}^{{N}_{t}} \frac{\vert {y}_{i} - \hat{{y}_{ι}} \vert}{{y}_{t}} . \qquad Eq . ( 11 )$$

The R² score, also known as the coefficient of determination, indicates the ability of the ML model to predict future samples, and is a measure of how well the ML model fits the data, with a score of 1 indicating a perfect fit and a score of 0 indicating a poor fit. A high R² score suggests that the model is able to make accurate predictions using the information it has learned from the training data. R² score can be calculated by the following:

$${R}^{2} ( y , \hat{y} ) = 1 - \frac{{\sum }_{i = 1}^{{N}_{t}} {( {y}_{i} - \hat{{y}_{ι}} )}^{2}}{{\sum }_{i = 1}^{{N}_{t}} {( {y}_{i} - \overline{{y}_{ι}} )}^{2}} , \qquad Eq . ( 12 )$$

where ŷₗ is the average value of yᵢ.

The features with normalized MI values above 2% based on any one of RSME, MAE, MSE, MAPE, and R² may be selected to develop the ML models 124 for each of the aforementioned elements. The 2% threshold may be predetermined through a trial and error process to ensure the highest predictive performance of the models. However, the value of the threshold may be smaller or greater than 2%.

The heat map of FIG. 7 indicates that several factors have a significant impact on the deterioration of various bridge elements. Age has the strongest MI with the deterioration of reinforced concrete abutments, steel protective coatings, steel bridge rails, wearing surfaces, reinforced concrete decks, prestressed concrete girders/beams, reinforced concrete pier caps, pourable joints, reinforced concrete bridge rails, reinforced concrete columns, reinforced concrete pier walls, reinforced concrete top flanges, strip seal joints, prestressed concrete closed web/box girders, and reinforced concrete girders/beams. Age may be computed as the difference between the year of construction and the year of inspection for each condition state.

Also according to the heat map of FIG. 7, the latitude and the longitude have significant impact on the deterioration of various bridge elements. The longitude has the strongest MI with the deterioration of reinforced concrete abutments, steel protective coatings, steel bridge rails, wearing surfaces, reinforced concrete decks, prestressed concrete girders/beams, reinforced concrete pier caps, pourable joints, reinforced concrete bridge rails, reinforced concrete columns, reinforced concrete pier walls, reinforced concrete top flanges, strip seal joints, prestressed concrete closed web/box girders, and reinforced concrete girders/beams. This correlation may be attributed to various factors related to climate and weather that can contribute to bridge component deterioration. For example, temperature fluctuations and exposure to moisture and humidity can cause concrete to expand and contract, leading to cracks and other forms of damage over time.

The structure length and the length of maximum span have a considerable MI with the deterioration of various bridge elements. The structure length is found to have the strongest MI with the deterioration of steel protective coatings, steel bridge rails, reinforced concrete decks, prestressed concrete girders/beams, reinforced concrete pier caps, and reinforced concrete bridge rails, as shown in the heat map of FIG. 7. The length of maximum span is found to have the strongest MI with the deterioration of steel protective coatings, steel bridge rails, reinforced concrete decks, prestressed concrete girders/beams, reinforced concrete pier caps, reinforced concrete bridge rails, and reinforced concrete columns, as shown in the heat map of FIG. 7.

Moreover, average daily traffic has the strongest MI with the deterioration of steel protective coatings, steel bridge rails, and reinforced concrete decks, as shown in the heat map of FIG. 7. Operating rating has the strongest MI with the deterioration of steel protective coatings, steel bridge rails, and reinforced concrete decks, as shown in the heat map of FIG. 7. Additionally, the type of wearing surface has a significant impact on the HI of the Reinforced Concrete Deck element, as shown in the heat map of FIG. 7. The type of wearing surface is the most influential factor in determining the deterioration of this element. Similarly, the bridge roadway width is a major factor influencing the HI of the Reinforced Concrete Pier Wall element, as shown in the heat map of FIG. 7. Finally, the deck width was identified as a major contributor to the HI of the Reinforced Concrete Girder/Beam element, as shown in the heat map of FIG. 7.

To evaluate the performance of the developed ML models, k-fold (k=5) cross validation may be used. In this process, the data is divided into k exclusive subsets, where k is set to 5, and each model is trained on k−1 subsets (80% of data) and tested on the remaining subset (20% of data) in each iteration. This approach provides a distribution of errors that assesses the general applicability of the ML models 124 to represent the variation in the dataset.

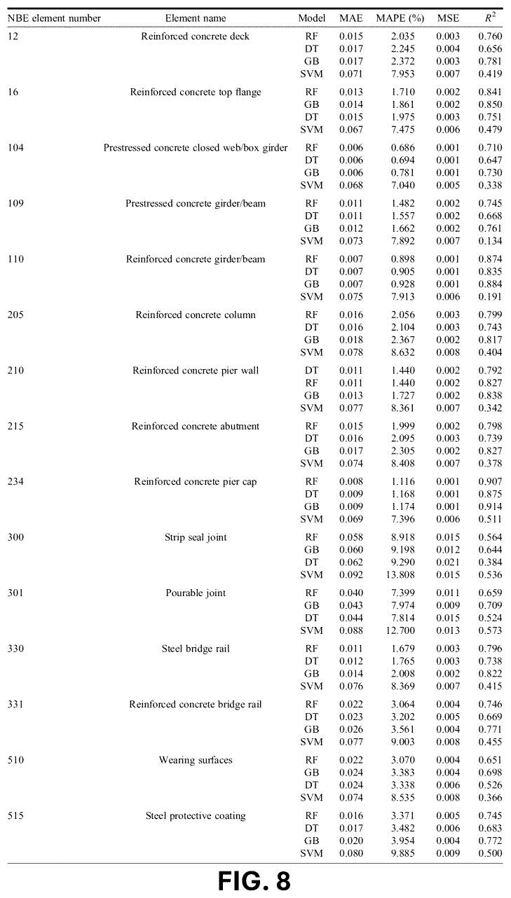

Additionally, four common evaluation metrics, including MAE, MSE, MAPE, and R², may be applied to evaluate the predictive performance of the ML models 124, as illustrated in FIG. 8. The values of predictive performance metrices vary over different elements, but a similar ranking of models can be identified. Based on the results of predictive performance metrics, the Random Forest (RF) method has the best performance in terms of MAE, MSE, MAPE, and R² metrics for all the elements. For example, RF has the best performance in predicting the HI of reinforced concrete deck with MAE, MAPE, MSE, and R² with values of 0.015, 2.035%, 0.003, and 0.760, respectively. MAE metric indicates that RF has the lowest prediction uniform error across the dataset compared to other methods. MAPE metric indicates that RF has the lowest relative error with respect to the magnitude of target values. Similarly, MSE metric indicates that RF has the best performance with respect to the magnitude of errors. Even though the R² metric is not the lowest for NBE element number 210 of the reinforced concrete pier wall compared to that of DT, RF generally appears to be the best explaining the variance of the HI for each of the element. Based on the results, RF may be selected to predict the deterioration of bridge elements in the optimization model due to its accuracy in predicting conditions of bridge elements.

Now turning back to FIG. 1, the maintenance optimization model 130 may identify optimal selection of maintenance interventions and their timing to maximize the performance of bridges while complying with available annual budgets. The maintenance optimization model 130 may be developed in three main phases, which include (1) identifying model decision variables; (2) formulating objective function and constraints; and (3) implementing model computations using binary linear programing. The cost-effectiveness of maintenance interventions may be evaluated based on the performance level of bridge elements, as measured by their HI, and the associated maintenance costs over the specified period. The maintenance optimization model 130 may further identify the optimum maintenance interventions for bridge elements based on predicted HI from the bridge element deterioration model selected by the data processor 122. The binary linear programing may be used to perform the computations of the maintenance optimization model 130 due to its capability of identifying optimal solutions in a short computational time. Thereby, the system 100 may be able to support decision makers, such as highway agencies, in allocating limited financial resources for bridge maintenance more efficiently and cost-effectively.

The maintenance optimization model 130 may include a maintenance plan generator 132 and an optimizer 134. The maintenance plan generator 132 may receive the predicted HIs of all elements of the infrastructure asset from the machine learning models 124, and obtain maintenance data from the third database 116. The maintenance data may include available interventions (e.g., sealing, patch, cleaning, minor repair, major repair, rehabilitation, replacement, etc.) and constraints, which includes annual budget limits, intervention costs, resource constraints, and the likes. Further, the maintenance data may include a minimum acceptable HI or condition rating thresholds, regulatory requirements, safety margins, and agency-defined service-level goals.

The maintenance plan generator 132 may construct all possible intervention scenarios that could be applied to each bridge element. Specifically, for each year and for each element, the maintenance plan generator 132 may identify every maintenance intervention action that is technically appropriate, cost-feasible, and structurally relevant. The maintenance intervention action may include do-nothing, minor repair, major repair, rehabilitation, or replacement. All feasible interventions may be represented as decision variables. In other words, these decision variables cover all feasible maintenance interventions for bridge elements including reinforced concrete deck, reinforced concrete top flange, prestressed concrete closed web/box girder, prestressed concrete girder/beam, reinforced concrete column, reinforced concrete pier wall, reinforced concrete abutment, reinforced concrete pier cap, reinforced concrete culvert, strip seal joint, pourable joint, steel bridge rail, reinforced concrete bridge rail, wearing surfaces, and steel protective coating.

The decision variable may be a binary decision variable, X_{e,y,i}, to model the selection of maintenance intervention number “i” in the year “y” for element “e” from a set of feasible alternatives. The decision variable, X_{e,y,i}, is designed to range from the first alternative intervention X_{e,y,l} for the element “e,” to alternative intervention X_{e,y,NAe} representing the total number of feasible interventions “NAe” for the element “e” in year “y”. These maintenance intervention alternatives may represent a spectrum of improvement in conditions, ranging from zero improvement, no maintenance intervention, to maximum repair of an element at 100% with user-defined increments such as 5%. “y” may range from y=1, the first year in a study period, to y=Y representing the total number of years in the study period. The value of “e” may range from, e=1 for reinforced concrete column to e=15 for strip seal joints. For example, X_{15,3,2}=1 represents the selection of the second maintenance intervention for Element type 15, strip seal joints, in Year 3.

The study period may be based on the smaller one of durations of the databases 112 and 114. For a specific element, the study period may be based on the smaller one of durations of the specific element present in the databases 112 and 114. In an aspect, the study period may be predetermined and zeros may be padded in a case where no data for the specific element exists during the predetermined period.

The optimizer 134 may formulate an objective function to identify optimal selection of maintenance interventions and their timing to maximize the performance of bridges while complying with available annual budgets. The bridge performance index over the study period may be calculated by weighted average of the performance index of the bridge elements including reinforced concrete deck, reinforced concrete top flange, prestressed concrete closed web/box girder, prestressed concrete girder/beam, reinforced concrete column, reinforced concrete pier wall, reinforced concrete abutment, reinforced concrete pier cap, reinforced concrete culvert, strip seal joint, pourable joint, steel bridge rail, reinforced concrete bridge rail, wearing surfaces, and steel protective coating during the predefined study period. To calculate the weighted average performance index of bridge elements, the weight of each element may be determined through expert opinion. For example, these weights may be determined based on the cost of the reconstruction and replacement of each element. The performance of each bridge element is measured based on HI. Accordingly, the condition of bridge elements for each year can be calculated based on the ML predictions, time of maintenance interventions, and improvement in conditions resulting from the implementation of maintenance interventions.

One of the main purposes of the optimizer 134 is to maximize the average of bridge performance indexes over the study period. The average of bridge performance index may be calculated by the following:

$$ABPI = \frac{{\sum }_{e = 1}^{{N}_{E}} {\sum }_{y = 1}^{{N}_{Y}} {EHI}_{e , y} \times {W}_{e}}{{\sum }_{e = 1}^{{N}_{E}} {\sum }_{y = 1}^{{N}_{Y}} {W}_{e}} , \qquad Eq . ( 13 )$$

where ABPI is the average of bridge performance index, N_{E} is the total number of elements, N_{Y} is the total number of the study years, EHI_{e,y} is the health index of element “e” in year “y”, and Wₑ is a user specified importance weight for element “e”. In an aspect, Wₑ be adjusted by the optimizer 134. The health index of element “e” in year “y” may be calculated by the following:

$${EHI}_{e , y} = {PHI}_{e , y} + {\sum }_{t = 1}^{y} {\sum }_{i = 1}^{{NA}_{e}} {X}_{e , y , i} \times {ME}_{e , y , i} , \qquad Eq . ( 14 )$$

where PHI_{e,y} is a predicted health index of element “e” in year “y”, which is estimated or predicted by using the ML models 124, ME_{e,y,i} represent improvement in condition of element “e” due to maintenance intervention “i” in year “y”.

To ensure the practicality and feasibility of the generated solutions, three types of constraints are integrated in the model, as follows: (1) annual maintenance budget; (2) maintenance intervention selection; and (3) minimum acceptable performance of bridge elements. The annual budget constraints are integrated in the model to ensure that the costs of bridge maintenance interventions do not exceed the available budget for each year. The available budget for each year is specified by the user, as shown in Eq. (14). Savings from year y are added to year (y+1) as savings from previous years can be used for maintenance of bridge elements in future years, as shown in Eq. (14). The element's maintenance cost is estimated in the model based on improvements in the element's conditions resulting from implementing maintenance intervention, measured by HI, and bridge element replacement cost, as shown in Eq. (14). The cost of replacing bridge elements may include costs for demolishing existing elements (if needed), materials, and labor and is calculated based on the quantity of each element and cost references such as RSMeans, which can be calculated by the following:

$${\sum }_{e = 1}^{{N}_{E}} {\sum }_{y = 1}^{t} {\sum }_{i = 1}^{{NA}_{e}} {X}_{e , y , i} \times {MC}_{e , y , i} < y \times AB , ∀ t = 1 , ... , Y , \qquad Eq . ( 15 )$$

where MC_{e,y,i} represents cost of maintenance intervention number “i” in year “y” for element “e,” and AB represents user-specified annual budget. The list of the cost of replacing bridge elements is not limited thereto but can include any other items readily appreciated by persons having skill in the art.

MC_{e,y,i} can be calculated based on construction cost of elements and improvement in their conditions owing to maintenance interventions as follows:

$${MC}_{e , y , i} = {ECC}_{e} \times ( \frac{{ME}_{e , y , i}}{100 - {THI}_{e}} ) , \qquad Eq . ( 16 )$$

where ECCₑ represents construction cost of element “e”, and THIₑ represents terminal health index, which represents the minimum acceptable condition for element “e”.

The maintenance intervention selection constraints are integrated in the model because of the utilization of linear programming to restrict the optimization model to select a single maintenance intervention from the set of alternatives for each element in each year, as shown in Eq. (17). Additionally, the minimum performance constraints are designed to guarantee that maintenance interventions are carried out on bridge elements prior to their performance index falling below their terminal health index, as shown in Eq. (18).

$$\begin{matrix}{\sum }_{i = 1}^{{NA}_{e}} {X}_{e , y , i} = 1 & ∀ t = 1 , ... , Y\end{matrix} , and \qquad Eq . ( 17 )$$

$$\begin{matrix}{EHI}_{e , y} \geq {THI}_{e} & ∀ y = 1 , ... , Y\end{matrix} . \qquad Eq . ( 18 )$$

The optimizer 134 may perform the computations of this optimization model using binary linear programing owing to its capability of identifying global optimum solutions in a short computational time.

A case study of a concrete bridge located in the state of Colorado is analyzed by using the developed system. The bridge was constructed in 2004 with the primary function of facilitating vehicular traffic and pedestrian walkway passage over the Coal Creek waterway with average daily traffic (ADT) of 5,245 vehicles. The bridge is classified as a local route and has a total length of 264.1 ft (80.5 m) with the largest span measuring 128.3 ft (39.1 m). The bridge comprises two main spans constructed using prestressed concrete. The main spans are designed using the stringer/multi-beam, and the deck type is concrete cast-in-place with a bituminous wearing surface. The optimization model is used to identify the optimal maintenance interventions for all the bridge elements including reinforced concrete deck, prestressed concrete beams, reinforced concrete columns, reinforced concrete abutments, reinforced concrete piers, strip seal expansion joints, pourable joint seals, steel bridge rail, reinforced concrete bridge rail, wearing sur-faces, and steel protective coating.

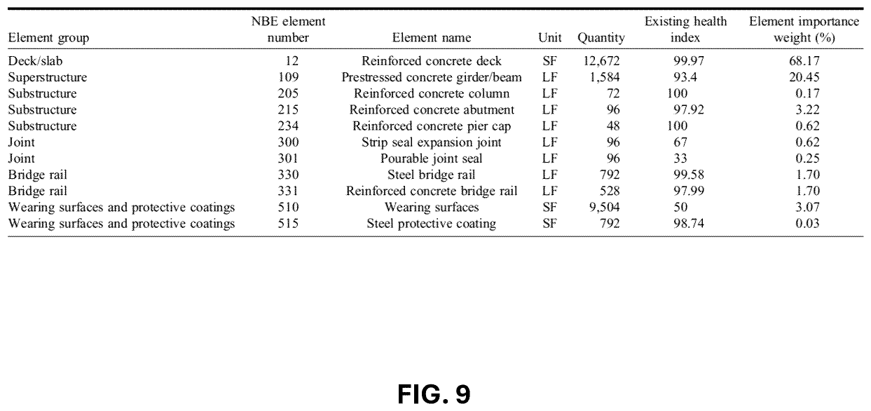

The case study input data are facilitated using NBI and NBE datasets to perform the optimization analysis. The collected data include information on the bridge's characteristics, such as bridge type, age, location, design, and materials, and geometry, as well as operational data such as average daily traffic and inventory rating. Additionally, data on specific bridge elements including the quantity and condition of each element as determined by the health index ratings are inputted into the model. A sample of the input data that summarizes the main bridge characteristics is illustrated in FIG. 9. The importance weight for each bridge element is calculated based on the cost of replacement and reconstruction for that element in relation to the sum of the cost of replacement and reconstruction for all elements according to Element importance weight (%) of FIG. 9. Additionally, the terminal health index, which represents the minimum acceptable condition for each element, is set at 40% for all bridge elements. Based on the collected input data, the health index of each bridge element in the case study was predicted for each year over the study period, using recursive forecasting method and the developed random forest models.

In an aspect, the deterioration forecasting model may perform recursive multi-step prediction using a sliding-window framework. The deterioration forecasting model may first generate a one-step-ahead prediction of the condition rating for the next year, which is then fed back as an input together with historical features for predicting subsequent years. This process may be repeated to obtain a multi-year forecast trajectory for each element. This recursive approach allows the deterioration forecasting model to propagate the effects of both natural deterioration and hypothetical maintenance interventions across the planning horizon, while capturing the compounding impact of forecast uncertainty in a controlled manner.

A trade-off between the bridge performance index and the required annual budget may be determined by incrementally increasing the available annual budget. In this way, the system 100 can be used to maximize average performance of the case study bridge over a study period of 50 years while complying with annual budgets that ranged from $26,000 to $125,000.

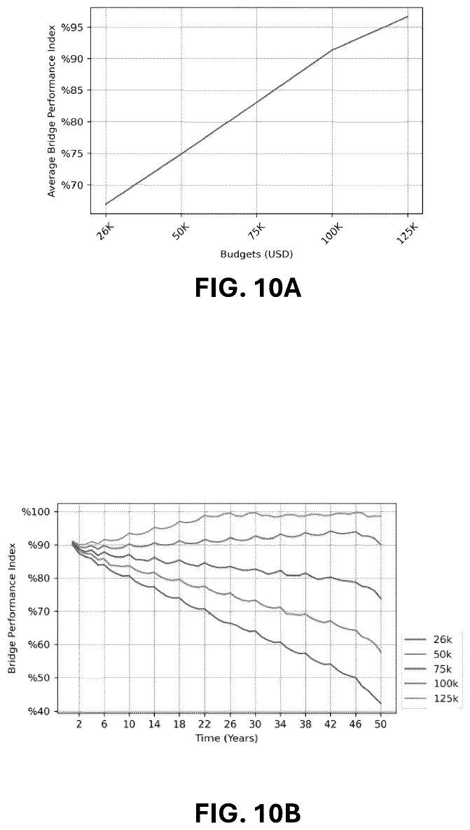

As illustrated in FIG. 10A, increase in the annual budget increases the average bridge performance index. For example, the $26,000 annual budget is identified as the minimum budget required to maintain the conditions of the bridge elements above the specified terminal health index of 40% during the study period. Further, although the bridge condition index can be improved, additional maintenance interventions have less significant impact. For example, increasing the budget from $50,000 to $75,000 results in 8.17% increase in the average performance index (i.e., 74.87%-83.03%), while increasing the budget from $100,000 to $125,000 results in a 5.31% increase (i.e., 91.32%-96.63%), as illustrated in FIG. 10A.

The results of system optimization may be caused by three key factors: (1) the initial HI and its evolution over the planning horizon for each system element, (2) the relative importance or weight assigned to the health index of each element when calculating the overall bridge performance index; and (3) the annual budget available for maintenance interventions. The results of the optimization model reveal that as the annual budget for bridge maintenance increases, the average performance index of the bridge improves.

These figures show that the model gradually spends the available budgets to prevent the degradation of bridge elements. As the annual budget increases, more costly maintenance interventions can be implemented, resulting in a greater impact on the average performance index, as illustrated in FIG. 10B. Conversely, with lower budgets, the model is restricted in scheduling costly maintenance interventions, leading to a greater degradation of the performance index, as illustrated in FIG. 10B.

Now referring back to FIG. 1, the system 100 may further include a maintenance plan output module 140, which generates output data 142 in the form of charts and/or action reports. The output data 142 may include: (1) annual maintenance cost charts of recommended maintenance plans within the study period; (2) charts of the annual bridge health index and the annual health index of individual elements over the study period; and (3) action reports summarizing detailed recommendations for maintenance interventions within the specified period and maintenance budget. The system 100 may be integrated with bridge management systems, such as BrM, where it can automatically retrieve the latest element condition data collected by inspectors from databases. This may facilitate the updating and retraining of the ML models, as well as performing maintenance optimization calculations. Based on the condition states and the other required input data, the maintenance plan output module 140 may generate the output data 142 with a user-defined format.

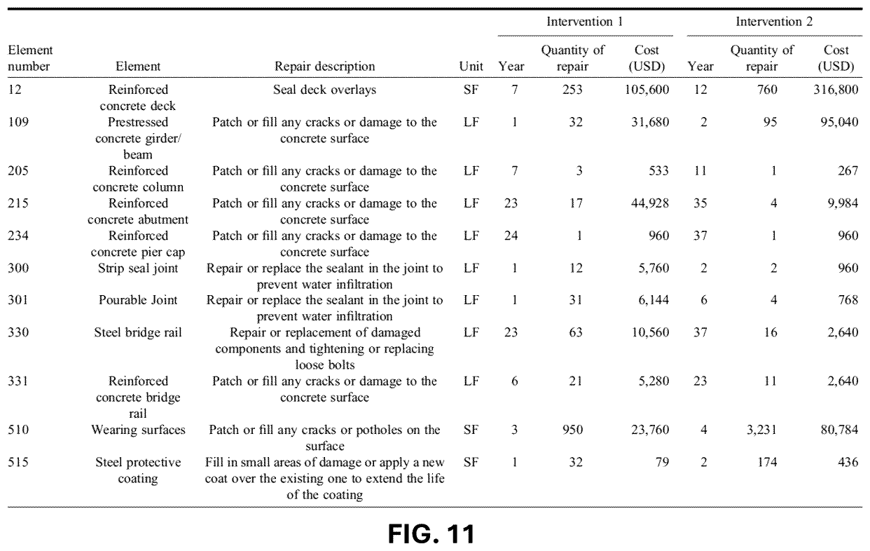

Turning attention to FIG. 11, illustrated is a sample action report for the annual budget of $75K for the above case study. For example, regarding Element Number 12 (i.e., reinforced concrete deck), the first maintenance intervention is recommended to perform “See deck overlays” is recommended at year 7 for 253 square foot (SF) at $105,600, and the second one is recommended at year 12 for 760 SF at $316,800. For year 1, “Strip seal joint” and “Pourable Joint” are recommended for a repair or replacement for 12 feet (LF) and 31 LF at $5,760 and $6,144, respectively, during the first maintenance intervention, and for 2 LF and 4 LF at $960 and $768, respectively, during the second maintenance intervention.

Thus, by incorporating physics-guided model and objective function model, the system 100 may be able to provide a systematic, data-driven framework for selecting the most effective features for predicting HI for each element and generating cost-efficient maintenance interventions across the lifecycle of bridge and culvert structures.

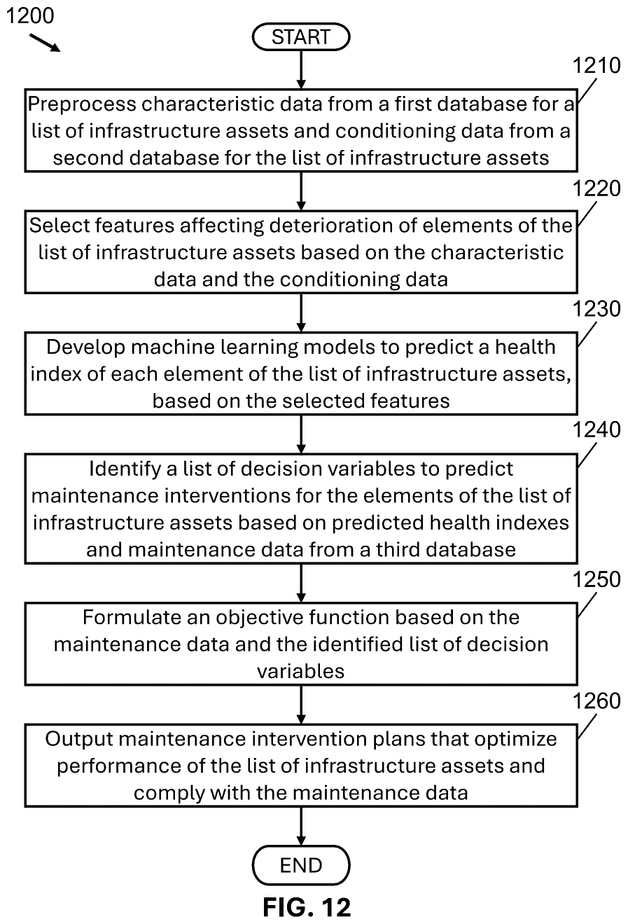

Turning attention to FIG. 12, illustrated is a flowchart of a method according to various aspects of the present disclosure. The method 1200 may employ an objective function to optimize an optimization model for forecasting deterioration of an infrastructure asset (e.g., bridges, culverts, or the likes). The method 1200 starts by performing step 1210 to preprocess characteristic data from a first database for a list of infrastructure assets and conditioning data from a second database for the list of infrastructure assets. The first database may be NBI and the second database may be NBE. The characteristics data from NBI may include bridge type, age, location, design, materials, geometry, as well as operational data such as average daily traffic and inventory rating, the quantity, and condition of each element. The element data may include element-level condition and quantity information. For example, the element data may include reinforced concrete deck, prestressed concrete girder/beam, reinforced concrete abutment, reinforced concrete pier cap, reinforced concrete column, steel bridge rail, reinforced concrete bridge rail, wearing surface, steel protective coating, and pourable joint. Further, the element data may include quantity data, such as area, length, count, percentage distribution of quantity in different condition states, and four standardized condition states (e.g., good, fair, poor, and failed).

The preprocessing may include concatenating the first data and the second data, cleaning the concatenated data by removing redundancy, and standardizing the concatenated data. During concatenating the first and second data, zeros may be added.

The method 1200 may further include step 1220, which is performed by Select features affecting deterioration of elements of the list of infrastructure assets based on the characteristic data and the conditioning data. To select the features, SHAP, MI, or any other metric values may be used to rank all features based on the affecting level toward deterioration. For example, age, age (item 27), latitude and longitude (items 16 and 17), structure length and maximum span length (items 49, 48), deck width (item 52), average daily traffic (item 29), operating rating (item 64), bridge roadway width (item 51), approach roadway width (item 32), average daily truck traffic (item 109), skew (item 34), functional class of inventory (item 26), type of wearing surface (item 108A), type of design/construction (item 43B), deck geometry (item 68), and approach roadway alignment (item 72) are ranked in order according to the heatmap in FIG. 7. Based on a threshold whether predetermined or user-defined, top ranked features, of which value is greater than the threshold, may be selected.

The method 1200 may further include step 1230, which is performed by developing machine learning models to predict a health index of each element of the list of infrastructure assets, based on the selected features. The machine learning models may include DT, RF, GV, SVM, or any other readily available AI models and are trained to predict a health index for each element of the infrastructure asset (e.g., bridge, culvert, or the likes).

With regard to the datasets from the first and second database, a portion of the datasets may be used to train the machine learning models and the other portion may be used to test the trained machine learning models. The ratio between them may be 5:5, 6:4, 7:3, 8:2, or 9:1.

Development or training may be performed for a set period of time so as to predict health indexes for all elements of the infrastructure asset. In an aspect, the best performing machine learning model may be used to predict the health indexes. In another aspect, a predetermined number of top performing machine learning models may be used to predict the same, and an average of health indexes for each element may be used to for the predicted health index for that element.

The method may further include step 1240, which is performed by Identify a list of decision variables to predict maintenance interventions for the elements of the list of infrastructure assets based on predicted health indexes and maintenance data from a third database. The maintenance data may include available interventions (e.g., sealing, patch, cleaning, minor repair, major repair, rehabilitation, replacement, etc.) and constraints, which includes annual budget limits, intervention costs, resource constraints, and the likes. Further, the maintenance data may include a minimum acceptable health index or condition rating thresholds, regulatory requirements, safety margins, and agency-defined service-level goals.

The method 1200 may further include step 1250, which is performed by formulating an objective function based on the maintenance data and the identified list of decision variables to identify optimal selection of maintenance interventions and their timing to maximize the performance of bridges while complying with available annual budgets. For example, the objective function may use an average of bridge performance indexes (ABPI), as formulated in Eq. (13) and (13). The formulated objective function may be further based on a predetermined minimum health index and the constraints. The main purpose of the objective function is to minimize a total maintenance cost and maximize structural performance. To achieve this dual or mini-max purpose, pareto-optimal solutions may be generated to visually and quantitatively compare alternative strategies under varying budgetary and risk preferences.

After the optimization at step 1250, the method further includes step 1260, which is performed by outputting maintenance intervention plans that optimize performance of the list of infrastructure assets and comply with the maintenance data. For example, as illustrated in FIG. 11, The maintenance intervention plan may include one or more maintenance intervention plans for each element at their timing.

In aspects, the method 1200 or any other control modules may be performed by a computing device, server, tablet, or cloud server or implemented by one or modules or programs executed by one or more computing systems. Interconnection of computing systems may be facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a plurality of web based services for communicating back and forth with clients.

Many computers are intended to be used by direct user interaction with the computer. As such, computers have input hardware and software user interfaces to facilitate user interaction. For example, a modern general-purpose computer may include a keyboard, mouse, touchpad, camera, etc. for allowing a user to input data into the computer. In addition, various software user interfaces may be available.

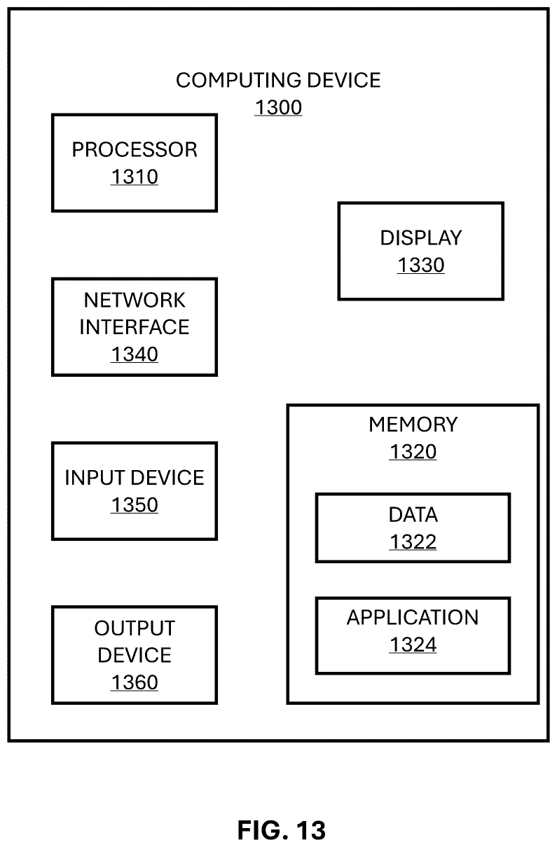

Turning now to FIG. 13, disclosed aspects may comprise or utilize a special purpose or general-purpose computing device 1300 including computer hardware, as discussed in greater detail below. The computing device 1300 may be a laptop or desktop computer, server, edge computer, or cloud computer, which can perform any functions, methods, processes disclosed above. The computing device 1300 may include a processor 1310, a memory 1320, a display 1330, a network interface 1340, an input device 1350, and/or an output device 1360. The memory 1320 includes any non-transitory computer-readable storage media for storing data and/or software that is executable by the processor 1310 and which controls the operation of the computing device 1300.

The computing device 1300 may include an operating system configured to perform executable instructions. The operating system is, for example, software, including programs and data, which manages hardware of the disclosed apparatus and provides services for execution of applications for use with the disclosed apparatus. Those of skill in the art will recognize that suitable operating systems include, by way of non-limiting examples, FreeBSD®, OpenBSD, NetBSD®, Linux®, Unix®, Apple® Mac OS X Server®, Oracle® Solaris®, Windows Server®, Windows®, Novell®, NetWare®, iOS®, Android®, or any other operating system readily available. In some aspects, the operating system is provided by cloud computing.

The processor 1310 may be a general purpose processor, a specialized graphics processing unit (GPU) configured to perform specific graphics processing tasks (e.g., parallel processing for training and testing data packets for potential cyberattacks) while freeing up the general-purpose processor to perform other tasks, and/or any number or combination of such processors, digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

The memory 1320 may include one or more solid-state storage devices such as flash memory chips. Alternatively or in addition to the one or more solid-state storage devices, the memory 1320 may include one or more mass storage devices connected to the processor 1310 through a mass storage controller (not shown) and a communications bus (not shown). Although the description of computer-readable media contained herein refers to a solid-state storage, it should be appreciated by those skilled in the art that computer-readable storage media can be any available media that can be accessed by the processor 1310. That is, computer readable storage media may include non-transitory, volatile and non-volatile, removable and non-removable media implemented in any method or technology for storage of information such as computer-readable instructions, data structures, program modules or other data. For example, computer-readable storage media includes random access memory (RAM), read-only memory (ROM), erasable programmable read-only memory (EPROM), electrically erasable programmable read-only memory (EEPROM), flash memory or other solid state memory technology, compact disc read-only memory (CD-ROM), digital video disc (DVD), Blu-Ray or other optical storage, magnetic cassettes, magnetic tape, magnetic disk storage or other magnetic storage devices, or any other medium which can be used to store the desired information and which can be accessed by the computing device 1300.

The memory 1320 may store application 1324 (e.g., fingerprint database, AI algorithm, etc.) and/or data 1322 (e.g., fingerprints). The application 1324 may, when executed by processor 1310, cause the display 1330 to present the user interface to provide information to users. The application 1324 may be one or more software programs stored in the memory 1320 and executed by the processor 1310 of the computing device 1300. The application 1324 may be installed directly on the computing device 1300 or via the network interface 1340. The application 1324 may run natively on the computing device 1300, as a web-based application, or any other format known to those skilled in the art.

In an aspect, the application 1324 may include a sequence of process-executable instructions, which can perform any of the herein described methods, programs, algorithms or codes, which are converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, C, Delphi, Fortran, Java, JavaScript, python, machine code, operating system command languages, Pascal, Perl, PL1, scripting languages, Visual Basic, meta-languages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The display 1330 may be a cathode ray tube (CRT), a liquid crystal display (LCD), a thin film transistor liquid crystal display (TFT-LCD), and an organic light emitting diode (OLED) display. In certain aspects, the OLED display is a passive-matrix OLED (PMOLED) or active-matrix OLED (AMOLED) display. In aspects, the display 1330 is a plasma display, and a video projector. In various aspects, the display 1330 may be interactive (e.g., having a touch screen or a sensor such as a camera, a 3D sensor, etc.) that can detect user interactions/gestures/responses and the like so as to serve as both an input and output device.

The network interface 1340 may be configured to connect to a network such as a local area network (LAN) consisting of a wired network and/or a wireless network, a wide area network (WAN), a wireless mobile network, a Bluetooth network, and/or the internet.

For example, the computing device 1300 may process digital measurement data obtained from the multi-arm spiral antenna, through the network interface 1340, to identify a direction of the transmission source of the signal. The computing device 1300 may update the AI algorithm, for example, the application 1324, via the network interface 1340. The computing device 1300 may also display processed results and any notification from training and/or testing on the display 1330.

The input device 1350 may be any device by means of which a user may interact with the computing device 1300, such as, for example, a mouse, keyboard, touch screen, and/or any other interface. The output device 1360 may include any connectivity port or bus, such as, for example, parallel ports, serial ports, universal serial busses (USB), or any other similar connectivity port known to those skilled in the art.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Computing system functionality can be enhanced by a computing system for ability to be interconnected to other computing systems and power generators via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Examples of software user interfaces include graphical user interfaces, text command line based user interface, function key or hot key user interfaces, and the like.

### EXAMPLE IMPLEMENTATIONS

In view of the foregoing, the present disclosure relates, for example and without being limited thereto, to the following clauses:
Clause 1. A system for forecasting deterioration of infrastructure assets, the system comprising: one or more processors; and a memory storing instructions that, when executed by the one or more processors, cause the system to perform: preprocessing characteristic data from a first database for a list of infrastructure assets and conditioning data from a second database for the list of infrastructure assets; selecting features affecting deterioration of elements of the list of infrastructure assets based on the characteristic data and the conditioning data; developing machine learning models to predict a health index of each element of the list of infrastructure assets, based on the selected features; identifying a list of decision variables to predict maintenance interventions for the elements of the list of infrastructure assets based on predicted health indexes and maintenance data from a third database; formulating an objective function based on the maintenance data and the identified list of decision variables; and outputting maintenance intervention plans that optimize performance of the list of infrastructure assets and comply with the maintenance data.
Clause 2. The system according to clause 1, wherein the conditioning data includes deterioration condition information of the elements of the list of infrastructure assets, the characteristic data includes type, age, location, construction, and geometry information of the elements of the list of infrastructure assets, and the maintenance data includes maintenance costs and constraints for the list of infrastructure assets.
Clause 3. The system according to clause 2, wherein the constraints comprise an annual maintenance budget, a maintenance intervention selection, and a minimum acceptable performance of the elements of the list of infrastructure assets.
Clause 4. The system according to clause 2, wherein the formulated objective function is further based on a predetermined minimum health index and the constraints.
Clause 5. The system according to clause 1, wherein the objective function is formulated to minimize a total maintenance cost and maximize structural performance.
Clause 6. The system according to clause 1, wherein preprocessing the first data and the second data comprises: concatenating the first data and the second data; cleaning the concatenated data by removing redundancy; and standardizing the concatenated data.
Clause 7. The system according to clause 6, wherein standardizing the concatenated data comprises: standardizing numerical data using a standard scaler; and encoding categories of the concatenated data using one-hot encoding.
Clause 8. The system according to clause 1, wherein the characteristic data and the conditioning data are divided into a first group for training the machine learning models and a second group for testing the predicted health indexes.
Clause 9. The system according to clause 1, wherein developing the machine learning models are performed with a physics-guided loss function, which includes an empirical error, a structural error, and a physical inconsistency.
Clause 10. The system according to clause 1, wherein the features are selected by using K-nearest-neighbors based mutual information estimation method.
Clause 11. A method for forecasting deterioration of an infrastructure asset, the method comprising: preprocessing characteristic data from a first database for a list of infrastructure assets and conditioning data from a second database for the list of infrastructure assets; selecting features affecting deterioration of elements of the list of infrastructure assets based on the characteristic data and the conditioning data; developing machine learning models to predict a health index of each element of the list of infrastructure assets, based on the selected features; identifying a list of decision variables to predict maintenance interventions for the elements of the list of infrastructure assets based on predicted health indexes and maintenance data from a third database; formulating an objective function based on the maintenance data and the identified list of decision variables; and outputting maintenance intervention plans that optimize performance of the list of infrastructure assets and comply with the maintenance data.
Clause 12. The method according to clause 11, wherein the conditioning data includes deterioration condition information of the elements of the list of infrastructure assets, the characteristic data includes type, age, location, construction, and geometry information of the elements of the list of infrastructure assets, and the maintenance data includes maintenance costs and constraints for the list of infrastructure assets.
Clause 13. The method according to clause 12, wherein the constraints comprise an annual maintenance budget, a maintenance intervention selection, and a minimum acceptable performance of the elements of the list of infrastructure assets.
Clause 14. The method according to clause 12, wherein the formulated objective function is further based on a predetermined minimum health index and the constraints.
Clause 15. The method according to clause 11, wherein the objective function is formulated to minimize a total maintenance cost and maximize structural performance.
Clause 16. The method according to clause 15, wherein preprocessing the first data and the second data comprises: concatenating the first data and the second data; cleaning the concatenated data by removing redundancy; and standardizing the concatenated data.
Clause 17. The method according to clause 16, wherein standardizing the concatenated data comprises: standardizing numerical data using a standard scaler; and encoding categories of the concatenated data using one-hot encoding.
Clause 18. The method according to clause 11, wherein the characteristic data and the conditioning data are divided into a first group for training the machine learning models and a second group for testing the predicted health indexes.
Clause 19. The method according to clause 11, wherein developing the machine learning models are performed with a physics-guided loss function, which includes an empirical error, a structural error, and a physical inconsistency.
Clause 20. A nontransitory computer-readable medium storing instructions that, when executed by a computer, cause the computer to perform a method comprising: preprocessing characteristic data from a first database for a list of infrastructure assets and conditioning data from a second database for the list of infrastructure assets; selecting features affecting deterioration of elements of the list of infrastructure assets based on the characteristic data and the conditioning data; developing machine learning models to predict a health index of each element of the list of infrastructure assets, based on the selected features; identifying a list of decision variables to predict maintenance interventions for the elements of the list of infrastructure assets based on predicted health indexes and maintenance data from a third database; formulating an objective function based on the maintenance data and the identified list of decision variables; and outputting maintenance intervention plans that optimize performance of the list of infrastructure assets and comply with the maintenance data.

The present disclosed may be embodied in other specific forms without departing from its spirit or characteristics. The described aspects are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A system for forecasting deterioration of infrastructure assets, the system comprising:
one or more processors; and
a memory storing instructions that, when executed by the one or more processors, cause the system to perform:
preprocessing characteristic data from a first database for a list of infrastructure assets and conditioning data from a second database for the list of infrastructure assets;
selecting features affecting deterioration of elements of the list of infrastructure assets based on the characteristic data and the conditioning data;
developing machine learning models to predict a health index of each element of the list of infrastructure assets, based on the selected features;
identifying a list of decision variables to predict maintenance interventions for the elements of the list of infrastructure assets based on predicted health indexes and maintenance data from a third database;
formulating an objective function based on the maintenance data and the identified list of decision variables; and
outputting maintenance intervention plans that optimize performance of the list of infrastructure assets and comply with the maintenance data.

2. The system according to claim 1, wherein the conditioning data includes deterioration condition information of the elements of the list of infrastructure assets, the characteristic data includes type, age, location, construction, and geometry information of the elements of the list of infrastructure assets, and the maintenance data includes maintenance costs and constraints for the list of infrastructure assets.

3. The system according to claim 2, wherein the constraints comprise an annual maintenance budget, a maintenance intervention selection, and a minimum acceptable performance of the elements of the list of infrastructure assets.

4. The system according to claim 2, wherein the formulated objective function is further based on a predetermined minimum health index and the constraints.

5. The system according to claim 1, wherein the objective function is formulated to minimize a total maintenance cost and maximize structural performance.

6. The system according to claim 1, wherein preprocessing the first data and the second data comprises:
concatenating the first data and the second data;
cleaning the concatenated data by removing redundancy; and
standardizing the concatenated data.

7. The system according to claim 6, wherein standardizing the concatenated data comprises:
standardizing numerical data using a standard scaler; and
encoding categories of the concatenated data using one-hot encoding.

8. The system according to claim 1, wherein the characteristic data and the conditioning data are divided into a first group for training the machine learning models and a second group for testing the predicted health indexes.

9. The system according to claim 1, wherein developing the machine learning models are performed with a physics-guided loss function, which includes an empirical error, a structural error, and a physical inconsistency.

10. The system according to claim 1, wherein the features are selected by using K-nearest-neighbors based mutual information estimation method.

11. A method for forecasting deterioration of an infrastructure asset, the method comprising:
preprocessing characteristic data from a first database for a list of infrastructure assets and conditioning data from a second database for the list of infrastructure assets;
selecting features affecting deterioration of elements of the list of infrastructure assets based on the characteristic data and the conditioning data;
developing machine learning models to predict a health index of each element of the list of infrastructure assets, based on the selected features;
identifying a list of decision variables to predict maintenance interventions for the elements of the list of infrastructure assets based on predicted health indexes and maintenance data from a third database;
formulating an objective function based on the maintenance data and the identified list of decision variables; and
outputting maintenance intervention plans that optimize performance of the list of infrastructure assets and comply with the maintenance data.

12. The method according to claim 11, wherein the conditioning data includes deterioration condition information of the elements of the list of infrastructure assets, the characteristic data includes type, age, location, construction, and geometry information of the elements of the list of infrastructure assets, and the maintenance data includes maintenance costs and constraints for the list of infrastructure assets.

13. The method according to claim 12, wherein the constraints comprise an annual maintenance budget, a maintenance intervention selection, and a minimum acceptable performance of the elements of the list of infrastructure assets.

14. The method according to claim 12, wherein the formulated objective function is further based on a predetermined minimum health index and the constraints.

15. The method according to claim 11, wherein the objective function is formulated to minimize a total maintenance cost and maximize structural performance.

16. The method according to claim 15, wherein preprocessing the first data and the second data comprises:
concatenating the first data and the second data;
cleaning the concatenated data by removing redundancy; and
standardizing the concatenated data.

17. The method according to claim 16, wherein standardizing the concatenated data comprises:
standardizing numerical data using a standard scaler; and
encoding categories of the concatenated data using one-hot encoding.

18. The method according to claim 11, wherein the characteristic data and the conditioning data are divided into a first group for training the machine learning models and a second group for testing the predicted health indexes.

19. The method according to claim 11, wherein developing the machine learning models are performed with a physics-guided loss function, which includes an empirical error, a structural error, and a physical inconsistency.

20. A nontransitory computer-readable medium storing instructions that, when executed by a computer, cause the computer to perform a method comprising:
preprocessing characteristic data from a first database for a list of infrastructure assets and conditioning data from a second database for the list of infrastructure assets;
selecting features affecting deterioration of elements of the list of infrastructure assets based on the characteristic data and the conditioning data;
developing machine learning models to predict a health index of each element of the list of infrastructure assets, based on the selected features;
identifying a list of decision variables to predict maintenance interventions for the elements of the list of infrastructure assets based on predicted health indexes and maintenance data from a third database;
formulating an objective function based on the maintenance data and the identified list of decision variables; and
outputting maintenance intervention plans that optimize performance of the list of infrastructure assets and comply with the maintenance data.
